(19) United States
(12) Patent Application Publication
(10) Pub. No.: US 2015/0158012 A1
(43) Pub. Date: Jun. 11, 2015

(54) ADSORPTION BASED AIR SEPARATION USING POROUS COORDINATION POLYMERS

(71) Applicant: Enovex Corporation, Saint John (CA)

(72) Inventors: Vaidhyanathan Ramanathan, Chennai (IN); Shyamapada Nandi, Pune (IN); Aparna Banerjee, Pune (IN)

(21) Appl. No.: 14/563,707

(22) Filed: Dec. 8, 2014

Related U.S. Application Data
(60) Provisional application No. 61/912,804, filed on Dec. 6, 2013.

(51) Int. Cl. B01J 20/22; C07F 3/06; B01J 20/30; B01D 53/04

(52) U.S. Cl. CPC B01J 20/226; B01D 53/04; C07F 3/06; B01J 20/3085; B01D 2253/204; B01D 2257/102; B01D 2257/104

(57) ABSTRACT

Zn metal-organic framework (ZnMOF) materials are described that selectively and reversibly binding oxygen and can be used in methods for removing oxygen from a fluid stream containing at least oxygen and one other component. Also described are methods for preparing these ZnMOFs.

This application claims priority to U.S. provisional application No. 61/912,804, which was filed on Dec. 6, 2013.

### FIELD OF THE INVENTION

The disclosure relates to Zn-based metal-organic framework materials that are useful for the selective separation and recovery of oxygen from oxygen-containing fluid streams, such as air.

### BACKGROUND OF THE INVENTION

Gases such as oxygen, nitrogen, hydrogen, acetylene, methane find application in a variety of industrial processes. Given that nitrogen makes up 78% and oxygen 21% of the atmospheric air, it forms the best source of generating pure stream of oxygen and nitrogen. Oxygen finds its use in a variety of production processes such as motor vehicles, electronic devices, solar cells, flat screens, glass and food.

Gas separations may be carried out by a number of methods including distillation at cryogenic temperatures, the use of permselective membranes, and by processes that utilize compositions that can reversibly and selectively adsorb a component of the gas mixture. For adsorption-based separation of air, current commercial technologies utilize zeolite molecular sieves as N₂-selective adsorbents and carbon molecular sieve (CMS) materials as O₂-selective adsorbents. These technologies, which are usually employed for the production of enriched nitrogen or oxygen, (rather than very high purity N₂ or O₂) have several inherent limitations which restrict their competitiveness against the cryogenic and membrane separation methods.

Synthetic zeolites reversibly adsorb nitrogen in preference to oxygen. When used for instance in a pressure-swing adsorption (PSA) process for the separation of air, the zeolite bed selectively takes up the nitrogen which is recovered by de-pressurization or evacuation of the bed. Oxygen thus generated find applications in fertilizer industries, medical supplies, food industries etc. The co-product, nitrogen gas, would also be treated in the project as an item of substantial commercial value. Such on-site PSA systems can produce up to 200 tons/day. Zeolite13x, a sodium aluminosilcate of the formula Na₈₆[(AlO₂)₈₆(SiO₂)₁₀₆].H₂O, is a preferred adsorbent for air separation from a pre-treated dry stream of air. In Zeolite 13x, the Si/Al ratio is tuned suitably to make it acidic. In such acidic forms, N₂ is adsorbed more strongly than O₂ as a consequence of the increased quadrapole-quadrapole interactions between N₂ and the extra-framework cations. For several years the PSA process has been in use and yet there has been no other adsorbent tried in place of Zeolite13x in a commercial set up. The drawback in this separation method is that it is performed inefficiently by adsorbing nitrogen which is the major component of air.

The potential advantages of selective oxygen sorbents have long been recognized and there has been much research effort directed at the synthesis of suitable materials. At the present time carbon molecular sieve (CMS) kinetically oxygen selective adsorbents are used in PSA air separation processes for the production of either enriched N₂ or O₂. Several factors limit the productivity and hence the cost-effectiveness of this technology. Even the most effective current CMS sorbents have a poor working O₂/N₂ selectivity in the PSA process. The necessarily short cycle times of the PSA process and the limiting oxygen adsorption kinetics lead to a poor utilization of the adsorption bed.

Many existing metal-organic framework materials that have been investigated for oxygen adsorption have been based on redox active metals (e.g. Fe and Co), wherein the metal plays a key role as the adsorption active site (see e.g., U.S. Pat. No. 5,294,418). But, such materials can display significant or in some cases severe degradation under prolonged oxygen exposure. Accordingly, there exists a need in the art for alternative oxygen-adsorbent materials that display decreased degradation under conditions relevant for separation of oxygen from fluid streams.

### BRIEF SUMMARY OF THE INVENTION

To address these issues, this disclosure describes a class of Zn metal-organic framework (ZnMOF) materials that are suitably stable and efficiently adsorb oxygen. In one aspect, the disclosure provides methods for removing oxygen from a fluid stream comprising oxygen and at least one other component comprising contacting the fluid stream with a Zn metal-organic framework (ZnMOF) that is capable of selectively and reversibly binding oxygen under conditions suitable to yield an oxygen-reduced fluid stream.

In another aspect, the disclosure provides Zn-based metal-organic frameworks (ZnMOFs) of formula ZnₙXₚY_{q}Zₐ, wherein n, p, q, X, Y, and Z are defined below. In another aspect, the disclosure provides method for preparing a ZnMOF, comprising heating a reaction mixture comprising H₂Y, HX, a zinc salt, a base, and a solvent under conditions suitable for formation of the ZnMOF, wherein Y and X are defined below.

### BRIEF DESCRIPTION OF THE DRAWINGS

FIG. 1a shows the comparison of the powder x-ray diffraction (PXRD) patterns of the as synthesized phase of ZnMOF1 (top trace) its corresponding simulated PXRD (bottom trace) patterns generated from the single crystal data. Note that in ZnMOF1 case, all the peaks are slightly right shifted and this is due to height offset during the sample preparation.

FIG. 1b shows the comparison of the PXRD patterns of the as synthesized phase of ZnMOF2 (top trace) with its corresponding simulated PXRD (bottom trace) patterns generated from the single crystal data.

FIG. 1c compares the PXRD of diaminotriazolate ZnMOF1 (bottom trace) and aminotriazolate ZnMOF2 (top trace); the arrows indicate the presence of a minor impurity form (ZnNOF4) in the sample of ZnMOF2.

FIG. 2 shows a thermogravimetric analysis (TGA) plot for ZnMOF1.

FIG. 3a illustrates one-dimensional chains in ZnMOF1 of Example 1 showing the orientation of the monodentately linking terephthalate and bridging water molecules; these tetrahedrally disposed terephthalates appear to give rise to uniform channels in the three dimensional structure of ZnMOF1.

FIG. 3b illustrates the three-dimensional structure of ZnMOF1 having two types of channels (about 11.5 Å and about 5.5 Å) along c-axis.

FIG. 3c illustrates the slit shaped pores (about 3 Å×5.5 Å) along in ZnMOF1 the a-direction.

FIG. 3d illustrates the slit shaped pores (about 3 Å×5.5 Å, factoring vander Waal radii) along in ZnMOF1 the b-direction.

FIG. 4 shows the powder x-ray diffraction (PXRD) pattern for ZnMOF3.

FIG. 5 compares the PXRD of diaminotriazolate ZnMOF1 (bottom trace) and ZnMOF4 (bottom trace).

FIG. 6a shows the Nitrogen adsorption (filled circles) and desorption (open circles) on ZnMOF1 carried out at 77K.

FIG. 6b shows a BET isotherm area model fit for the adsorption data of FIG. 6a, giving a surface area of 350.736 m²/g with r=0.999701.

FIG. 6c shows a Langmuir isotherm model fit for the adsorption data of FIG. 6a, giving a surface area of 501.424 m²/g with r=0.999.

FIG. 6d shows the DFT modeling of ZnMOF1 using the 77K N₂ adsorption data using a QSDFT adsorption model considering a combination of cylindrical/spherical/slit pores based on the single crystal structure. The fit obtained appears good (error: 0.443%), hence was further analyzed to derive the pore size distribution.

FIG. 6e shows the pore size distribution present in ZnMOF1 as derived from DFT modeling.

FIG. 7 shows the O₂ adsorption (filled squares) and desorption (open squares) on ZnMOF1 at 30° C.

FIG. 8a shows N₂ adsorption (filled circles) and desorption (open circles) on ZnMOF2 at 77K on isopropanol activated sample.

FIG. 8b shows the DFT modeling of ZnMOF2 using the 77K N₂ adsorption data using a QSDFT adsorption model considering a combination of cylindrical/slit pores based on the single crystal structure. The fit obtained appears good (error: 0.035%), hence was further analyzed to derive the pore size distribution.

FIG. 8c shows the pore size distribution present in ZnMOF2 as derived from DFT modeling.

FIG. 9 shows the O₂ adsorption (filled circles) and desorption (open circles) on ZnMOF1 at 10° C.

FIG. 10 shows the comparison of the O₂ adsorption on ZnMOF1 (30° C., upper trace) and ZnMOF2 (10° C., lower trace).

FIG. 11 shows the PXRDs corresponding to ZnMOF1 following different solvent and solvent plus heat treatments. From top to bottom the traces represent, water soaking, heating at 110° C., refluxing in methanol, refluxing in water, exchanging with acetone, as synthesized, and simulated.

### DETAILED DESCRIPTION OF THE INVENTION

We have found that certain solid state compositions comprising Zn-based metal-organic frameworks (ZnMOFs) can selectively adsorb oxygen for its separation and recovery from fluid mixtures, such as air.

O₂-selective ZnMOF Adsorbants

The term “ZnMOF” means a porous metal-organic framework comprising Zn and multi-dentate organic ligands capable of coordinating to Zn (i.e., organic ligands comprising at least two functional groups capable of coordinating to Zn, such that each ligand is coordinated to at least two different Zn atoms). The ZnMOF may be optionally solvated (e.g., hydrated) or may be anhydrous. The ZnMOF may be crystalline, amorphous, a combination of crystalline forms, or any mixture thereof.

“Solvated” and “solvate” means that the referenced composition (i.e., ZnMOF) contains a stoichiometric or non-stoichiometric amount solvent molecules that are non-covalently associated with the crystalline lattice of the composition (i.e., the solvent is held within the crystalline lattice of the composition by intermolecular forces). Where the solvent is water, the solvate is a “hydrate.” Examples of solvents include, but are not limited to, water, methanol, ethanol, isopropanol, N,N-dimethylformamide, N,N-dimethylacetamide, dimethylsulfoxide, tetrahydrofuran, acetonitrile, toluene, benzene, chloroform, dichloromethane, and mixtures thereof.

In certain embodiments, the ZnMOF has an average pore size (e.g., average pore diameter) along its largest axis between about 6 Å and about 25 Å. In certain embodiments, the average pore size is between about 8 Å and about 16 Å as observed from their single crystal structures (see figures in the appendix). As is familiar to those skilled in the art, this matches with the pore sizes estimated from Havorth-Kavoze models and DFT models using the nitrogen adsorption data carried out 77K.

A ZnMOF shows “selective binding to oxygen” or “selectively binds oxygen” when the ZnMOF preferentially binds to oxygen with respect to nitrogen as measured by gas adsorption isotherms at 298 K according to methods familiar to those skilled in the art. In certain embodiments, the molar ratio of oxygen to nitrogen adsorbed is greater than 1, or greater than 2, or greater than 5 or greater than 10 or greater than 20. For example, the ratio of oxygen to nitrogen adsorbed can be between greater than 1 and 20, or between about 2 and 20, or between about 5 and 20, or between about 10 and 20. A ZnMOF shows “reversible binding to oxygen” or “reversibly binds oxygen” when at least 50 wt %, or at least 60%, or at least 70%, or at least 80%, or at least 90%, or at least 95%, or at least 99% of any adsorbed oxygen is desorbed from the material when exposed to a vacuum, and retains the ability to re-adsorb oxygen after the desorption process (e.g., the ZnMOF can be regenerated).

In particular, the ZnMOFs are Zn-based metal-organic frameworks that include at least one optionally substituted “azole ligand.” The azole ligand comprises a 5-membered heteroaryl group that contain at least 2 annular nitrogen atoms, where the azole ligand is capable of coordinating to two or more Zn atoms, and the ligand is capable of coordinating at least one Zn atom by one of the annular nitrogen atoms. The azole ligand can be neutral or anionic (e.g., due to deprotonation of the ligand). In the latter case, the deprotonated, anionic azole ligand can be termed an “azolate ligand.” Alternatively, the azole ligand can be cationic due to protonation of the ligand.

Examples of optionally substituted azole ligands include optionally substituted monocyclic 5-membered heteroaryl groups and optionally substituted multicyclic fused heterocyclyl groups (as defined below) that include the 5-membered heteroaryl group. Suitable 5-membered heteroaryl groups, alone or as part of the optionally substituted multicyclic fused heterocyclyl group include pyrazole, imidazole, triazole, and tetrazole groups, such as [1,2,3]-triazole and [1,2,4]-triazole groups. Suitable multicyclic fused heterocyclyl groups that contain the 5-membered heteroaryl group include adenine, guanine, benzimidazole, benzopyrazole, benzotriazole, imidazopyridine (e.g., 3H-imidazo[4,5-b]pyridine), 4,5,6,7-tetrahydro-1H-benzo[d]imidazole, 4,5,6,7-tetrahydro-1H-indazole, and 4,5,6,7-tetra hydro-1H-benzo[d][1,2,3]triazole, each of which may be optionally substituted.

“Optionally substituted” means the referenced group is functionalized, as is familiar to those skilled in the art, at one or more functionalizable positions with groups that do not interfere with the intended function of the overall material (e.g., the ZnMOF formed with an optionally substituted ligand). Suitable functional groups include, for example, one or more (e.g., one to four, or one to three, or one to two, or one) groups that are each independently selected from the group consisting of halogen, —R⁰, C₁₋₄alkyl, C₁₋₄haloalkyl, C₂₋₄alkenyl, C₂₋₄alkynyl, wherein each R⁰ is independently nitro, cyano, —OR⁰⁰, —N(R⁰⁰)₂, SR⁰⁰, C(O)R⁰⁰, —C(O)OR⁰⁰, —C(O)N(R⁰⁰)₂, SO₂R⁰⁰, —SO₂OR⁰⁰, —SO₂N(R⁰⁰)₂, —OC(O)R⁰⁰, —N(R⁰⁰)C(O)R⁰⁰, —OC(O)OR⁰⁰, —OC(O)N(R⁰⁰)₂, —N(R⁰⁰)C(O)OR⁰⁰, —N(R⁰⁰)C(O)N(R⁰⁰)₂, —OC(O)R⁰⁰, N(R⁰⁰)C(O)R⁰⁰, —OC(O)OR⁰⁰, —OC(O)N(R⁰⁰)₂, —N(R⁰⁰)C(O)OR⁰⁰, —N(R⁰⁰)C(O)N(R⁰⁰)₂, —OS(O)₂R⁰⁰, —N(R⁰⁰)S(O)₂R⁰⁰, —OS(O)₂OR⁰⁰, —N(R⁰⁰)S(O)₂OR⁰⁰, —N(R⁰⁰)S(O)₂N(R⁰⁰)₂, aryl, heteroaryl, C₃₋₈cycloalkyl, or 3-8 membered heterocyclyl, wherein each R⁰⁰ is independently hydrogen or C₁₋₄alkyl.

In certain embodiments, functional groups for the optional substitution are one or more (e.g., one to four, or one to three, or one to two, or one) groups that are each independently selected from the group consisting of halogen, —R⁰, C₁₋₄alkyl, C₁₋₄haloalkyl, C₂₋₄alkenyl, C₂₋₄alkynyl, —C₁₋₄alkyl-R⁰, wherein each R⁰ is independently nitro, cyano, —OR⁰⁰, —N(R⁰⁰)₂, —SR⁰⁰, —C(O)R⁰⁰, —C(O)OR⁰⁰, —C(O)N(R⁰⁰)₂, —SO₂R⁰⁰, —SO₂OR⁰⁰, —SO₂N(R⁰⁰)₂, —OC(O)R⁰⁰, —N(R⁰⁰)C(O)R⁰⁰, —OC(O)OR⁰⁰, —OC(O)N(R⁰⁰)₂, —N(R⁰⁰)C(O)OR⁰⁰, —N(R^{O0})C(O)N(R⁰⁰)₂, —OS(O)₂R⁰⁰, — N(R⁰⁰)S(O)₂R⁰⁰, —OS(O)₂OR⁰⁰, —N(R⁰⁰)S(O)₂OR⁰⁰, —N(R⁰⁰)S(O)₂N(R⁰⁰)₂, wherein each R⁰⁰ is independently hydrogen or C₁₋₄alkyl. In certain embodiments, functional groups for optional substitution are one or more (e.g., one to four, or one to three, or one to two, or one) groups that are each independently selected from the group consisting of halogen, nitro, cyano, C₁₋₄alkyl, C₁₋₄haloalkyl, —OR⁰⁰, —N(R⁰⁰)₂, —SR⁰⁰, —C(O)R⁰⁰, —C(O)OR⁰⁰, —C(O)N(R⁰⁰)₂, —SO₂R⁰⁰, —SO₂N(R⁰⁰)₂, —OC(O)R⁰⁰, —OC(O)N(R⁰⁰)₂, —OC(O)N(R⁰⁰)₂, —N(R⁰⁰)C(O)R⁰⁰, or —N(R⁰⁰)S(O)₂R⁰⁰, wherein each R⁰⁰ is independently hydrogen or C₁₋₄alkyl.

In certain embodiments, the optional functional groups described in any of the preceding embodiments exclude —COOH groups, such as, when the optional substituent is attached to the azole ligand.

In one embodiment, the ZnMOF comprises one or more optionally substituted azole ligands (e.g., one or more optionally substituted azolate ligands). For example, in one embodiment, an optionally substituted azolate can be of any one of formulae (Ia)-(Ii),

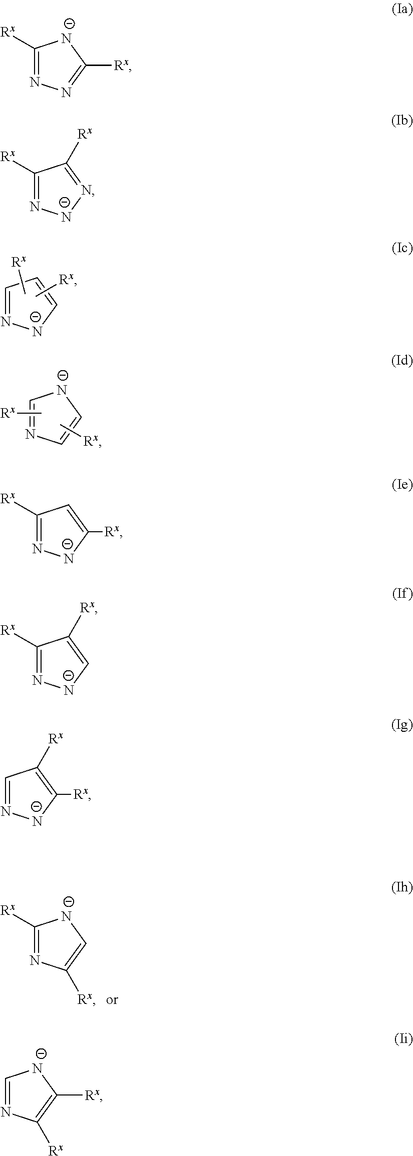

wherein
each R^{X} is independently hydrogen, halogen, —R^{X1}, C₁₋₄alkyl, C₁₋₄haloalkyl, C₂₋₄alkenyl, C₂₋₄alkynyl, —C₁₋₄alkyl-R^{X1}, —C₁₋₄alkyl-R^{X3}, wherein
   each R^{X1} is independently —N(R^{X2})₂, —OR^{X2}, —C(O)R^{X2}, —C(O)OR^{X2}, —C(O)N(R^{X2})₂, —N(R^{X2})C(O)R^{X2}, —N(R^{X2})C(O)OR^{X2}, —N(R^{X2})C(O)N(R^{X2})₂, —N(R^{X2})S(O)₂R^{X2}, —N(R^{X2})S(O)₂OR^{X2}, —N(R^{X2})S(O)₂N(R^{X2})₂, —OC(O)R^{X2}, —OC(O)OR^{X2}, —OC(O)N(R^{X2})₂, aryl, heteroaryl, C₃₋₈cycloalkyl, or 3-8 membered heterocyclyl; and
   each R^{X3} is independently nitro, cyano, —SR^{X2}, —SO₂R^{X2}, —SO₂OR^{X2}, —SO₂N(R^{X2})₂, —OS(O)₂R^{X2}, or —OS(O)₂OR^{X2};
   wherein each R^{X2} is independently hydrogen or C₁₋₄alkyl.

In one embodiment of the azolate of any one of formulae (Ia)-(Ii), each R^{X} is independently hydrogen, halogen, —R^{X1}, C₁₋₄alkyl, C₁₋₄haloalkyl, C₂₋₄alkenyl, C₂₋₄alkynyl, —C₁₋₄alkyl-R^{X1}, —C₁₋₄alkyl-R^{X3}, wherein each R^{X1} is independently —N(R^{X2})₂, —OR^{X2}, —C(O)R^{X2}, —C(O)OR^{X2}, —C(O)N(R^{X2})₂, —N(R^{X2})C(O)R^{X2}, —N(R^{X2})C(O)OR^{X2}, —N(R^{X2})C(O)N(R^{X2})₂, —N(R^{X2})S(O)₂R^{X2}, —N(R^{X2})S(O)₂OR^{X2}, —N(R^{X2})S(O)₂N(R^{X2})₂, —OC(O)R^{X2}, —OC(O)OR^{X2}, or —OC(O)N(R^{X2})₂; and each R^{X3} is independently nitro, cyano, —SR^{X2}, —SO₂R^{X2}, —SO₂OR^{X2}, —SO₂N(R^{X2})₂—OS(O)₂R^{X2}, or —OS(O)₂OR^{X2}; wherein each R^{X2} is independently hydrogen or C₁₋₄alkyl.

In another embodiment of the azolate of any one of formulae (Ia)-(Ii), each R^{X} is independently hydrogen, halogen, C₁₋₄alkyl, C₁₋₄haloalkyl, C₂₋₄alkenyl, C₂₋₄alkynyl, —N(R^{X2})₂, —OR^{X2}, —C(O)R^{X2}, —C(O)OR^{X2}, —C(O)N(R^{X2})₂, —N(R^{X2})C(O)R^{X2}, —N(R^{X2})C(O)OR^{X2}, —N(R^{X2})C(O)N(R^{X2})₂, —N(R^{X2})S(O)₂R^{X2}, —N(R^{X2})S(O)₂OR^{X2}, —N(R^{X2})S(O)₂N(R^{X2})₂, —OC(O)R^{X2}, —OC(O)OR^{X2}, —OC(O)N(R^{X2})₂, —SR^{X2}, —SO₂R^{X2}, —SO₂OR^{X2}, —SO₂N(R^{X2})₂, —OS(O)₂R^{X2}, or —OS(O)₂OR^{X2}; wherein each R^{X2} is independently hydrogen or C₁₋₄alkyl.

In another embodiment of the azolate of any one of formulae (Ia)-(Ii), each R^{X} is independently hydrogen, halogen, —N(R^{X2})₂, —OR^{X2}, —N(H)C(O)R^{X2}, —N(H)C(O)OR^{X2}, —N(H)C(O)N(R^{X2})₂, —N(H)S(O)₂R^{X2}, —N(R^{X2})S(O)₂OR^{X2}, or —N(R^{X2})S(O)₂N(R^{X2})₂, —OC(O)R^{X2}, —OC(O)OR^{X2}, —OC(O)N(R^{X2})₂, —OS(O)₂R^{X2}, or —OS(O)₂OR^{X2}; wherein each R^{X2} is independently hydrogen or C₁₋₄alkyl.

In another embodiment of the azolate of any one of formulae (Ia)-(Ii), R^{X} is not —COOH.

In another embodiment of the azolate of any one of formulae (Ia)-(Ii), each R^{X} is independently hydrogen, —N(R^{X2})₂, or —OR^{X2}, wherein each R^{X2} is independently hydrogen or C₁₋₄alkyl.

In another embodiment of the azolate of any one of formulae (Ia)-(Ii), each R^{X} is independently hydrogen, —NH(R^{X2}), or —OR^{X2}, wherein R^{X2} is hydrogen or C₁₋₄alkyl.

In another embodiment of the azolate of any one of formulae (Ia)-(Ii), each R^{X} is —NH₂.

In another embodiment of the azolate of any one of formulae (Ia)-(Ii), at least one R^{X} group is hydrogen.

In another embodiment of the azolate of any one of formulae (Ia)-(Ii), one R^{X} group is hydrogen and the other R^{X} group is halogen, —R^{X1}, C₁₋₄alkyl, C₁₋₄haloalkyl, C₂₋₄alkenyl, C₂₋₄alkynyl, —C₁₋₄alkyl-R^{X1}, —C₁₋₄alkyl-R^{X3}, wherein each R^{X1} is independently —N(R^{X2})₂, —OR^{X2}, —C(O)R^{X2}, —C(O)OR^{X2}, —C(O)N(R^{X2})₂, —N(R^{X2})C(O)R^{X2}, —N(R^{X2})C(O)OR^{X2}, —N(R^{X2})C(O)N(R^{X2})₂, —N(R^{X2})S(O)₂R^{X2}, —N(R^{X2})S(O)₂OR^{X2}, —N(R^{X2})S(O)₂N(R^{X2})₂, —OC(O)R^{X2}, —OC(O)OR^{X2}, or —OC(O)N(R^{X2})₂; and each R^{X3} is independently nitro, cyano, —SR^{X2}, —SO₂R^{X2}, —SO₂OR^{X2}, —SO₂N(R^{X2})₂, —OS(O)₂R^{X2}, or —OS(O)₂OR^{X2}; wherein each R^{X2} is independently hydrogen or C₁₋₄alkyl.

In another embodiment of the azolate of any one of formulae (Ia)-(Ii), one R^{X} group is hydrogen and the other R^{X} group is halogen, C₁₋₄alkyl, C₁₋₄haloalkyl, C₂₋₄alkenyl, C₂₋₄alkynyl, —N(R^{X2})₂, —OR^{X2}, —C(O)R^{X2}, —C(O)OR^{X2}, —C(O)N(R^{X2})₂, —N(R^{X2})C(O)R^{X2}, —N(R^{X2})C(O)OR^{X2}, —N(R^{X2})C(O)N(R^{X2})₂, —N(R^{X2})S(O)₂R^{X2}, —N(R^{X2})S(O)₂OR^{X2}, —N(R^{X2})S(O)₂N(R^{X2})₂, —OC(O)R^{X2}, —OC(O)OR^{X2}, —OC(O)N(R^{X2})₂, —SR^{X2}, —SO₂R^{X2}, —SO₂OR^{X2}, —SO₂N(R^{X2})₂, —OS(O)₂R^{X2}, or —OS(O)₂OR^{X2}; wherein each R^{X2} is independently hydrogen or C₁₋₄alkyl.

In another embodiment of the azolate of any one of formulae (Ia)-(Ii), one R^{X} group is hydrogen and the other R^{X} group is halogen, —N(R^{X2})₂, —OR^{X2}, —N(H)C(O)R^{X2}, —N(H)C(O)OR^{X2}, —N(H)C(O)N(R^{X2})₂, —N(H)S(O)₂R^{X2}, —N(R^{X2})S(O)₂OR^{X2}, or —N(R^{X2})S(O)₂N(R^{X2})₂, —OC(O)R^{X2}, —OC(O)OR^{X2}, —OC(O)N(R^{X2})₂, —OS(O)₂R^{X2}, or —OS(O)₂OR^{X2}; wherein each R^{X2} is independently hydrogen or C₁₋₄alkyl.

In another embodiment of the azolate of any one of formulae (Ia)-(Ii), one R^{X} group is hydrogen and the other R^{X} group is —N(R^{X2})₂ or —OR^{X2}, wherein each R^{X2} is independently hydrogen or C₁₋₄alkyl.

In another embodiment of the azolate of any one of formulae (Ia)-(Ii), one R^{X} group is hydrogen and the other R^{X} group is —NH(R^{X2}) or —OR^{X2}, wherein R^{X2} is hydrogen or C₁₋₄alkyl.

In another embodiment of the azolate of any one of formulae (Ia)-(Ii), one R^{X} group is hydrogen and the other R^{X} is —NH₂.

In another embodiment, the azolate is of formulae (Ia) or (Ib) and R^{X} is defined according to any of the preceding embodiments.

In another embodiment, the azolate is of formulae (la) and R^{X} is defined according to any of the preceding embodiments.

In certain embodiments, the azolate is [1,2,4]-triazolate, 3-amino-[1,2,4]-triazolate, 2,5-diamino-[1,2,4]-triazolate, and/or mixtures thereof. In certain embodiments, the azolate is 3-amino-[1,2,4]-triazolate. In certain embodiments, the azolate is 2,5-diamino-[1,2,4]-triazolate.

In certain embodiments, the ZnMOFs further includes, in addition to the at least one azole ligand, one or more multi-dentate ligands that are capable of coordinating to two or more separate Zn atoms (e.g, 2-6, or 2-5, or 2-4, or 2-3, or 2, or 3, or 4, or 5, or 6 separate Zn atoms). Examples of multidentate ligands include bi-dentate ligands, that is, ligands that are capable of coordinating to two separate Zn atoms; tri-dentate ligands, that is, ligands that are capable of coordinating to three separate Zn atoms; and/or mixtures thereof ligands. Examples of bi-dentate ligands include ligands of formula (IIa)-(IIc),

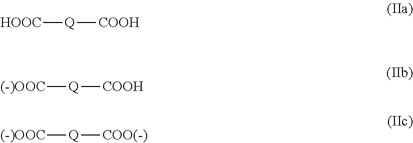

wherein Q is a bond, C₁₋₁₀alkyl, C₁₋₁₀haloalkyl, C₂₋₁₀alkenyl, C₂₋₁₀alkynyl, aryl, heteroaryl, C₃₋₁₂cycloalkyl, or 3-12 membered heterocyclyl, each of which may be optionally substituted, as defined above. In one embodiment of formula (IIa), (IIb), and/or (IIc), Q is C₁₋₁₀alkyl, C₁₋₁₀ haloalkyl, C₂₋₁₀alkenyl, C₂₋₁₀alkynyl, aryl, heteroaryl, C₃₋₁₂cycloalkyl, or 3-12 membered heterocyclyl, each of which may be optionally substituted, as defined above.

In other examples, the ligand is an optionally substituted dicarboxylate ligand (i.e., formula (IIc), such as an optionally substituted aryldicarboxylate ligand (i.e., formula (IIc), where Q is optionally substituted aryl). Examples of optionally substituted aryldicarboxylate ligands include optionally substituted terephthalate ligands, an optionally substituted isophthalate ligands, and mixtures thereof.

In other examples, the, one or more multi-dentate ligands is a mixture of an optionally substituted dicarboxylate ligand according to formula IIb and IIc, such as a mixture of optionally substituted aryldicarboxylate ligands of formula IIb and IIc, where Q is optionally substituted aryl (e.g., phenyl) in each ligand.

Examples of tri-dentate ligands include optionally substituted aryltricarboxylate acid ligands and optionally substituted 1,3,5-benzenetricarboxylate acid ligands.

In one particular embodiment, the multi-dentate ligands are one or more optionally substituted terephthalate ligands. In another embodiment, the multi-dentate ligands are one or more optionally substituted isophthalate ligands. In another embodiment, the multi-dentate ligands are one or more optionally substituted 1,3,5-benzenetricarboxylate ligands. In another embodiment, the multi-dentate ligands are a mixture of optionally substituted terephthalate ligands and optionally substituted isophthalate ligands.

In one embodiment, the ligands can be of formula (IId), (IId′), (IId″), (IIe), (IIe′), (IIe″) and/or (IIf),

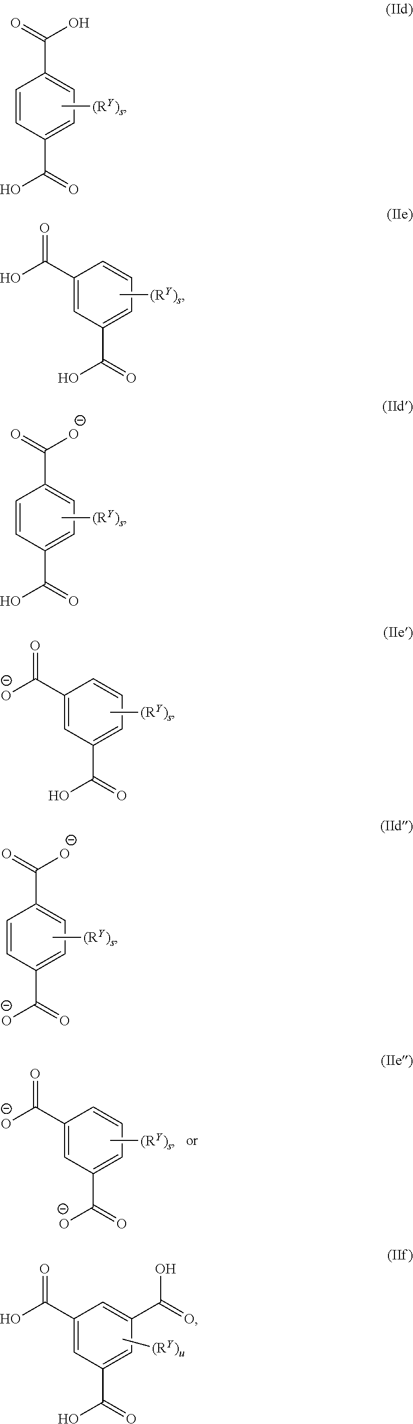

wherein
s is 0, 1, 2, 3, or 4;
u is 0, 1, 2, or 3; and
each R^{Y} is independently halogen, —R^{Y1}, C₁₋₄alkyl, C₁₋₄haloalkyl, C₂₋₄alkenyl, C₂₋₄alkynyl, —C₁₋₄alkyl-R^{Y1}, wherein
   each R^{Y1} is independently nitro, cyano, —OR^{Y2}, —N(R^{Y2})₂, —SR^{Y2}, —C(O)R^{Y2}, —C(O)OR^{Y2}, —C(O)N(R^{Y2})₂, —SO₂R^{Y2}, —SO₂OR^{Y2}, —SO₂N(R^{Y2})₂, —OC(O)R^{Y2}, —N(R^{Y2})C(O)R^{Y2}, —OC(O)OR^{Y2}, —OC(O)N(R^{Y2})₂, —N(R^{Y2})C(O)OR^{Y2}, —N(R^{Y2})C(O)N(R^{Y2})₂, —OS(O)₂R^{Y2}, —N(R^{Y2})S(O)₂R^{Y2}, —OS(O)₂OR^{Y2}, —N(R^{Y2})S(O)₂OR^{Y2}, —N(R^{Y2})S(O)₂N(R^{Y2})₂, aryl, heteroaryl, C₃₋₈cycloalkyl, or 3-8 membered heterocyclyl, wherein each R^{Y2} is independently hydrogen or C₁₋₄alkyl.

In one embodiment of the ligands of formula (IId), (IId′), (IId″), (IIe), (IIe′), and (IIe″), s is 0, 1, 2, or 3. In another embodiment of the ligands of formula (IId), (IId′), (IId″), (IIe), (IIe′), and (IIe″), s is 0, 1, or 2. In another embodiment of the ligands of formula (IId), (IId′), (IId″), (IIe), (IIe′), and (IIe″), s is 0 or 1. In another embodiment of the ligands of formula (IId), (IId′), (IId″), (IIe), (IIe′), and (IIe″), s is 0. In another embodiment of the ligands of formula (IId), (IId′), (IId″), (IIe), (IIe′), and (IIe″), s is 1. In another embodiment of the ligands of formula (IId) or (IIe), s is 1, 2, 3, or 4. In another embodiment of the ligands of formula (IId), (IId′), (IId″), (IIe), (IIe′), and (IIe″), s is 1, 2, or 3. In another embodiment of the ligands of formula (IId), (IId′), (IId″), (IIe), (IIe′), and (IIe″), s is 1 or 2.

In one embodiment of the ligands of formula (IId), (IId′), and (IId″), s is 0, 1, 2, or 3. In another embodiment of the ligands of formula (IId), (IId′), and (IId″), s is 0, 1, or 2. In another embodiment of the ligands of formula (IId), (IId′), and (IId″), s is 0 or 1. In another embodiment of the ligands of formula (IId), (IId′), and (IId″), is 0. In another embodiment of the ligands of formula (IId), (IId′), and (IId″), s is 1. In another embodiment of the ligands of formula (IId), (IId′), and (IId″), s is 1, 2, 3, or 4. In another embodiment of the ligands of formula (IId), (IId′), and (IId″), s is 1, 2, or 3. In another embodiment of the ligands of formula (IId), (IId′), and (IId″), s is 1 or 2.

In one embodiment of the ligands of formula (IIe), (IIe′), and (IIe″), s is 0, 1, 2, or 3. In another embodiment of the ligands of formula (IIe), (IIe′), and (IIe″), s is 0, 1, or 2. In another embodiment of the ligands of formula (IIe), (IIe′), and (IIe″), s is 0 or 1. In another embodiment of the ligands of formula (IIe), (IIe′), and (IIe″), s is 0. In another embodiment of the ligands of formula (IIe), s is 1. In another embodiment of the ligands of formula (IIe), (IIe′), and (IIe″), s is 1, 2, 3, or 4. In another embodiment of the ligands of formula (IIe), (IIe′), and (IIe″), s is 1, 2, or 3. In another embodiment of the ligands of formula (IIe), (IIe′), and (IIe″), s is 1 or 2.

In another embodiment of the ligands of formula (IIf), u is 0, 1, or 2. In another embodiment of the ligands of formula (IIf), u is 0 or 1. In another embodiment of the ligands of formula (IIf), u is 0. In another embodiment of the ligands of formula (IIf), u is 1. In another embodiment of the ligands of formula (IIf), u is 1, 2, or 3. In another embodiment of the ligands of formula (IIf), u is 1 or 2.

In an embodiment of any of the preceding embodiments of the ligands of formula (IId), (IId′), (IId″), (IIe), (IIe′), and (IIe″), and/or (IIf), each R^{Y} is independently halogen, —R^{Y1}, C₁₋₄alkyl, C₁₋₄haloalkyl, C₂₋₄alkenyl, C₂₋₄alkynyl, —C₁₋₄alkyl-R^{Y1}, wherein each R^{Y1} is independently nitro, cyano, —OR^{Y2}, N(R^{Y2})₂, —SR^{Y2}, —C(O)R^{Y2}, —C(O)OR^{Y2}, —C(O)N(R^{Y2})₂, —SO₂R^{Y2}, —SO₂OR^{Y2}, —SO₂N(R^{Y2})₂, —OC(O)R^{Y2}, —N(R^{Y2})C(O)R^{Y2}, —OC(O)OR^{Y2}, —OC(O)N(R^{Y2})₂, —N(R^{Y2})C(O)OR^{Y2}, —N(R^{Y2})C(O)N(R^{Y2})₂, —OS(O)₂R^{Y2}, —N(R^{Y2})S(O)₂R^{Y2}, —OS(O)₂OR^{Y2}, —N(R^{Y2})S(O)₂OR^{Y2}, or —N(R^{Y2})S(O)₂N(R^{Y2})₂, wherein each R^{Y2} is independently hydrogen or C₁₋₄alkyl.

In another embodiment of any of the preceding embodiments of ligands of formula (IId), (IId′), (IId″), (IIe), (IIe′), and (IIe″), and/or (IIf), each R^{Y} is independently halogen, C₁₋₄alkyl, C₁₋₄haloalkyl, nitro, cyano, —OR^{Y2}, —N(R^{Y2})₂, —SR^{Y2}, —C(O)R^{Y2}, —C(O)OR^{Y2}, —C(O)N(R^{Y2})₂, —SO₂R^{Y2}, —SO₂OR^{Y2}, —SO₂N(R^{Y2})₂, —OC(O)R^{Y2}, —N(R^{Y2})C(O)R^{Y2}, —OC(O)OR^{Y2}, —OC(O)N(R^{Y2})₂, —N(R^{Y2})C(O)OR^{Y2}, N(R^{Y2})C(O)N(R^{Y2})₂, —OS(O)₂R^{Y2}, —N(R^{Y2})S(O)₂R^{Y2}, —OS(O)₂OR^{Y2}, —N(R^{Y2})S(O)₂OR^{Y2}, or —N(R^{Y2})S(O)₂N(R^{Y2})₂, wherein each R^{Y2} is independently hydrogen or C₁₋₄alkyl.

In another embodiment of any of the preceding embodiments of ligands of formula (IId), (IId′), (IId″), (IIe), (IIe′), and (IIe″), and/or (IIf), each R^{Y} is independently halogen, C₁₋₄alkyl, C₁₋₄haloalkyl, nitro, cyano, —OR^{Y2}, —N(R^{Y2})₂, —C(O)R^{Y2}, —C(O)OR^{Y2}, —C(O)N(R^{Y2})₂, —OC(O)R^{Y2}, —N(R^{Y2})C(O)R^{Y2}, —OC(O)OR^{Y2}, —OC(O)N(R^{Y2})₂, —N(R^{Y2})C(O)OR^{Y2}, —N(R^{Y2})C(O)N(R^{Y2})₂, —N(R^{Y2})S(O)₂R^{Y2}, —N(R^{Y2})S(O)₂OR^{Y2}, or —N(R^{Y2})S(O)₂N(R^{Y2})₂, wherein each R^{Y2} is independently hydrogen or C₁₋₄alkyl.

In another embodiment of any of the preceding embodiments of ligands of formula (IId), (IId′), (IId″), (IIe), (IIe′), and (IIe″), and/or (IIf), each R^{Y} is independently halogen, C₁₋₄alkyl, C₁₋₄haloalkyl, nitro, cyano, —OR^{Y2}, —N(R^{Y2})₂, —C(O)R^{Y2}, —C(O)OR^{Y2}, or —C(O)N(R^{Y2})₂, wherein each R^{Y2} is independently hydrogen or C₁₋₄alkyl.

In one embodiment, the O₂-selective ZnMOF adsorbents can be, a ZnMOF, ZnMOF solvate, ZnMOF hydrate that comprises (or consists essentially of, or consists of) Zn, one or more optionally substituted azole ligands (e.g., azolate ligands), and one or more optionally substituted dicarboxylate ligands.

Where the O₂-selective ZnMOF adsorbents contains “more than one” or “one or more” optionally substituted dicarboxylate ligands, it means that the two or more dicarboxylate ligand types differ by the optional substitutents on the dicarboxylate ligands (e.g., at least one different R^{Y} group) and/or differ with respect to the “Q” group as defined above and/or differ by the deprotonation state of the dicarboxylate ligands (e.g., a mixture of mono- and di-deprotonated forms as show in formulae (IIb) and (IIc), supra).

In certain embodiments, the one or more optionally substituted dicarboxylate ligands are a mixture of ligands of formulae (IId′) and (IId″), where R^{Y} may be defined as in any preceding embodiment. In certain embodiments, the one or more optionally substituted dicarboxylate ligands are a mixture of ligands of formulae (IIe′) and (IIe″), where R^{Y} may be defined as in any preceding embodiment. In certain embodiments, the one or more optionally substituted dicarboxylate ligands are a mixture of ligands of formulae (IId′) and (IId″), wherein s is 0. In certain embodiments, the one or more optionally substituted dicarboxylate ligands are a mixture of ligands of formulae (IIe′) and (IIe″) wherein s is 0.

In certain other embodiments, the one or more optionally substituted dicarboxylate ligands are a 1:1 (molar) mixture of ligands of formulae (IId′) and (IId″), where R^{Y} may be defined as in any preceding embodiment. In certain embodiments, the one or more optionally substituted dicarboxylate ligands are a 1:1 (molar) mixture of ligands of formulae (IIe′) and (IIe″), where R^{Y} may be defined as in any preceding embodiment.

In certain other embodiments, the one or more optionally substituted dicarboxylate ligands are a 1:1 (molar) mixture of ligands of formulae (IId′) and (IId″), wherein s is 0. In certain embodiments, the one or more optionally substituted dicarboxylate ligands are a 1:1 (molar) mixture of ligands of formulae (IIe′) and (IIe″), wherein s is 0.

Similarly, where the O₂-selective ZnMOF adsorbents contains “more than one” or “one or more” optionally substituted azole ligand, it means that the two or more azole ligand types differ by the optional substitutents on the azole ligands (e.g., at least one different R^{X} group as exemplified in formulae (Ia)-(Ii)) and/or differ with respect to the five-membered heteroaryl group that forms part of the ligand, as exemplified by formulae (Ia)-(Ii).

Without being limited by theory, the dicarboxylate ligand can chelate with Zn to form rigid building units, while the azole or azolate ligands may act as tri-dentate ligands, thereby providing additional stability and providing additional charges that may favor the incorporation of more Zn centers in the MOF for the construction of microporous three-dimensional networks.

Notably, dicarboxylate ligands have been shown to form a variety cluster based building units with transition metals. Particularly noteworthy are the OM₄ type oxo-clusters found in MOF-5 type compounds and the M₂O₄ type paddle-wheel clusters present in HKUST-1 type MOFs. Certain triazolate-based MOFs with stable and frequently occurring Zn-triazolate dimeric building units have been reported (see, Chui et al., Science 1999, 283, 1148; Vaidhyananthan et al., Science 2010, 330, 650; and Vaidhyanathan et al., Angew. Chem. Int. Ed., Engl. 2012, 51, 1826) that show highly stable three-dimensional MOFs when the triazolate building units are pillared with dicarboxylate ligands. Without being limited by theory, it is believed that ZnMOF based on tridentate azolates that strongly bind with Zn can increase stability of the framework, in particular, by inhibiting hydrolysis at susceptible oxo-clusters within the framework. This can increase overall stability of the metal-organic frameworks upon exposure to water vapor present in air.

In particular, O₂-selective ZnMOF sorbents can be according to the formula, ZnₙXₚY_{q}Zₐ or a solvate or hydrate thereof, wherein a is 0 or an integer greater than 0; n, p, and q are each integers greater than 0; X is one or more optionally substituted azole ligands; Y is one or more multidentate ligands; and Z is H₂O, where a, n, p, and q are selected to provide a neutral compound. In one embodiment, the one or more multidentate ligands are one or more bi-dentate ligands, one or more tri-dentate ligands, or a mixture thereof, as defined above.

Where X represents two or more optionally substituted azole ligands, p is equal to the sum of the molar ratios of each optionally substituted azole ligand. Similarly, where Y represents two or more bi-dentate ligands, q is equal to the sum of the molar ratios of each bi-dentate ligand. In certain embodiments, X and Y can each be as defined in any embodiment of formulae (Ia)-(Ii) and/or (IIa)-(IIf), (IId′), (IId″), (IIe′), or (IIe″).

In another embodiment, the O₂-selective ZnMOF sorbents can be according to the formula (III),

ZnₙXₚY_{q}Zₐ (III)

or a solvate or hydrate thereof, wherein

a is 0 or an integer greater than 0;

Z is H₂O;

n, p, and q are each integers greater than 0, where a, n, p, and q are selected such that formula (III) is a neutral compound;

each X is independently of the formula,

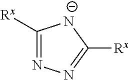

wherein
each R^{X} is independently hydrogen, halogen, —R^{X1}, C₁₋₄alkyl, C₁₋₄haloalkyl, C₂₋₄alkenyl, C₂₋₄alkynyl, —C₁₋₄alkyl-R^{X1}, —C₁₋₄alkyl-R^{X3}, wherein
   each R^{X1} is independently —N(R^{X2})₂, —OR^{X2}, —C(O)R^{X2}, —C(O)OR^{X2}, —C(O)N(R^{X2})₂, —N(R^{X2})C(O)R^{X2}, —N(R^{X2})C(O)OR^{X2}, —N(R^{X2})C(O)N(R^{X2})₂, —N(R^{X2})S(O)₂R^{X2}, —N(R^{X2})S(O)₂OR^{X2}, —N(R^{X2})S(O)₂N(R^{X2})₂, —OC(O)R^{X2}, —OC(O)OR^{X2}, —OC(O)N(R^{X2})₂, aryl, heteroaryl, C₃₋₈cycloalkyl, or 3-8 membered heterocyclyl; and
   each R^{X3} is independently nitro, cyano, —SR^{X2}, —SO₂R^{X2}, —SO₂OR^{X2}, —SO₂N(R^{X2})₂, —OS(O)₂R^{X2}, or —OS(O)₂OR^{X2};
   wherein each R^{X2} is independently hydrogen or C₁₋₄alkyl; and
each Y is independently of the formula,

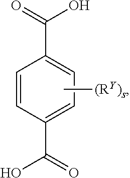

or a mono- or di-deprotonated form thereof,
wherein s is 0, 1, 2, 3, or 4; and
each R^{Y} is independently halogen, —R^{Y1}, C₁₋₄alkyl, C₁₋₄haloalkyl, C₂₋₄alkenyl, C₂₋₄alkynyl, —C₁₋₄alkyl-R^{Y1}, wherein
   each R^{Y1} is independently nitro, cyano, —OR^{Y2}, —N(R^{Y2})₂, —SR^{Y2}, —C(O)R^{Y2}, —C(O)OR^{Y2}, —C(O)N(R^{Y2})₂, —SO₂R^{Y2}, —SO₂OR^{Y2}, —SO₂N(R^{Y2})₂, —OC(O)R^{Y2}, —N(R^{Y2})C(O)R^{Y2}, —OC(O)OR^{Y2}, —OC(O)N(R^{Y2})₂, —N(R^{Y2})C(O)OR^{Y2}, —N(R^{Y2})C(O)N(R^{Y2})₂, —OS(O)₂R^{Y2}, —N(R^{Y2})S(O)₂R^{Y2}, —OS(O)₂OR^{Y2}, —N(R^{Y2})S(O)₂OR^{Y2}, —N(R^{Y2})S(O)₂N(R^{Y2})₂, aryl, heteroaryl, C₃₋₈cycloalkyl, or 3-8 membered heterocyclyl, wherein each R^{Y2} is independently hydrogen or C₁₋₄alkyl.

In further embodiments of formulae (III), Y is as defined in any preceding embodiment (e.g., any of formulae (IIa)-(IIf), (IId′), (IId″), (IIe′), and (IIe″), and any embodiment thereof).

In one embodiment, the sorbents of formula (III) can be according to the formula (IIIa),

ZnₙXₚY¹_{q1}Y²_{q2}Zₐ (IIIa)
or a solvate or hydrate thereof, wherein a, n, p, X and Z are as defined in formula (III); and q1 and q2 are each integers, where a, n, p, q1 and q2 are selected such that formula (IIIa) is a neutral compound;
Y¹ is of the formula,

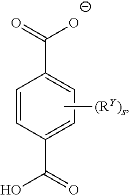

wherein s is 0, 1, 2, 3, or 4; and
each R^{Y} is independently halogen, —R^{Y1}, C₁₋₄alkyl, C₁₋₄haloalkyl, C₂₋₄alkenyl, C₂₋₄alkynyl, —C₁₋₄alkyl-R^{Y1}, wherein
   each R^{Y1} is independently nitro, cyano, —OR^{Y2}, —N(R^{Y2})₂, —SR^{Y2}, —C(O)R^{Y2}, —C(O)OR^{Y2}, —C(O)N(R^{Y2})₂, —SO₂R^{Y2}, —SO₂OR^{Y2}, —SO₂N(R^{Y2})₂, —OC(O)R^{Y2}, —N(R^{Y2})C(O)R^{Y2}, —OC(O)OR^{Y2}, —OC(O)N(R^{Y2})₂, —N(R^{Y2})C(O)OR^{Y2}, —N(R^{Y2})C(O)N(R^{Y2})₂, —OS(O)₂R^{Y2}, —N(R^{Y2})S(O)₂R^{Y2}, —OS(O)₂OR^{Y2}, —N(R^{Y2})S(O)₂OR^{Y2}, —N(R^{Y2})S(O)₂N(R^{Y2})₂, aryl, heteroaryl, C₃₋₈cycloalkyl, or 3-8 membered heterocyclyl, wherein each R^{Y2} is independently hydrogen or C₁₋₄alkyl; and
Y² is of the formula

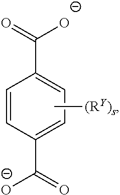

wherein R^{Y} and s are independently as defined above.

In one embodiment of formula (IIIa), s is 0.

In another embodiment of formula (IIIa), the sorbents can be according to the formula (IIIb),

ZnₙXₚY_{q}Zₐ (IIIb).

In further embodiments of formulae (III), (IIIa), and (IIIb), X is as defined in any preceding embodiment (e.g., any of formulae (Ia)-(Ii) and any embodiment thereof). In one embodiment of formula (IIIb), s is 0.

In another embodiment, the O₂-selective ZnMOF sorbents can be according to the formula (IV),

ZnₙXₚY_{q}Zₐ (IV)
or a solvate or hydrate thereof, wherein
a is 0 or an integer greater than 0;
Z is H₂O;
n, p, and q are each integers greater than 0, where a, n, p, and q are selected such that formula (IV) is a neutral compound;
each X is independently of the formula,

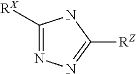

wherein
R^{X} is hydrogen or —R^{Z}; and
each R^{Z} is independently halogen, —R^{X1}, C₁₋₄alkyl, C₁₋₄haloalkyl, C₂₋₄alkenyl, C₂₋₄alkynyl, —C₁₋₄alkyl-R^{X1}, or —C₁₋₄alkyl-R^{X3}, wherein
   each R^{X1} is independently —N(R^{X2})₂, —OR^{X2}, —C(O)R^{X2}, —C(O)OR^{X2}, —C(O)N(R^{X2})₂, —N(R^{X2})C(O)R^{X2}, —N(R^{X2})C(O)OR^{X2}, —N(R^{X2})C(O)N(R^{X2})₂, —N(R^{X2})S(O)₂R^{X2}, —N(R^{X2})S(O)₂OR^{X2}, or —N(R^{X2})S(O)₂N(R^{X2})₂, —OC(O)R^{X2}, —OC(O)OR^{X2}, OC(O)N(R^{X2})₂, aryl, heteroaryl, C₃₋₈cycloalkyl, or 3-8 membered heterocyclyl; and
   each R^{X3} is independently nitro, cyano, —SR^{X2}, —SO₂R^{X2}, —SO₂OR^{X2}, SO₂N(R^{X2})₂, —OS(O)₂R^{X2}, or —OS(O)₂OR^{X2};
   wherein each R^{X2} is independently hydrogen or C₁₋₄alkyl; and
each Y is independently of the formula,

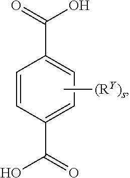

or a mono- or di-deprotonated form thereof,
wherein s is 0, 1, 2, 3, or 4; and
each R^{Y} is independently halogen, —R^{Y1}, C₁₋₄alkyl, C₁₋₄haloalkyl, C₂₋₄alkenyl, C₂₋₄alkynyl, or —C₁₋₄alkyl-R^{Y1}, wherein
   each R^{Y1} is independently nitro, cyano, —OR^{Y2}, —N(R^{Y2})₂, —SR^{Y2}, —C(O)R^{Y2}, —C(O)OR^{Y2}, —C(O)N(R^{Y2})₂, —SO₂R^{Y2}, —SO₂OR^{Y2}, —SO₂N(R^{Y2})₂, —OC(O)R^{Y2}, —N(R^{Y2})C(O)R^{Y2}, —OC(O)OR^{Y2}, —OC(O)N(R^{Y2})₂, —N(R^{Y2})C(O)OR^{Y2}, —N(R^{Y2})C(O)N(R^{Y2})₂, —OS(O)₂R^{Y2}, —N(R^{Y2})S(O)₂R^{Y2}, —OS(O)₂OR^{Y2}, —N(R^{Y2})S(O)₂OR^{Y2}, or —N(R^{Y2})S(O)₂N(R^{Y2})₂, aryl, heteroaryl, C₃₋₈cycloalkyl, or 3-8 membered heterocyclyl, wherein each R^{Y2} is independently hydrogen or C₁₋₄alkyl.

In further embodiments of formulae (IV), Y is as defined in any preceding embodiment (e.g., any of formulae (IIa)-(IIf), (IId′), (IId″), (IIe′), and (IIe″), and any embodiment thereof).

In one embodiment, the sorbents can be according to the formula (IVa),

ZnₙXₚY¹_{q1}Y²_{q2}Zₐ (IVa)
or a solvate or hydrate thereof, wherein a, n, p, X, and Z are as defined in formula (IV); and q1 and q2 are each integers greater than 0, where a, n, p, q1 and q2 are selected such that formula (IVa) is a neutral compound;
Y¹ is of the formula,

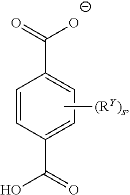

wherein s is 0, 1, 2, 3, or 4; and
each R^{Y} is independently halogen, —R^{Y1}, C₁₋₄alkyl, C₁₋₄haloalkyl, C₂₋₄alkenyl, C₂₋₄alkynyl, —C₁₋₄alkyl-R^{Y1}, wherein
   each R^{Y1} is independently nitro, cyano, —OR^{Y2}, —N(R^{Y2})₂, —SR^{Y2}, —C(O)R^{Y2}, —C(O)OR^{Y2}, —C(O)N(R^{Y2})₂, —SO₂R^{Y2}, —SO₂OR^{Y2}, —SO₂N(R^{Y2})₂, —OC(O)R^{Y2}, —N(R^{Y2})C(O)R^{Y2}, —OC(O)OR^{Y2}, —OC(O)N(R^{Y2})₂, —N(R^{Y2})C(O)OR^{Y2}, —N(R^{Y2})C(O)N(R^{Y2})₂, —OS(O)₂R^{Y2}, —N(R^{Y2})S(O)₂R^{Y2}, —OS(O)₂OR^{Y2}, —N(R^{Y2})S(O)₂OR^{Y2}, —N(R^{Y2})S(O)₂N(R^{Y2})₂, aryl, heteroaryl, C₃₋₈cycloalkyl, or 3-8 membered heterocyclyl, wherein each R^{Y2} is independently hydrogen or C₁₋₄alkyl; and
Y² is of the formula

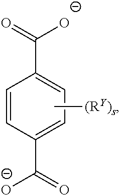

wherein R^{Y} and s are independently as defined above.

In one embodiment of formula (IVa), the sorbents can be according to the formula (IVb),

Zn₂XY¹Y²Z (IVb).

In further embodiments of formulae (IV), (IVa), and (IVb), X is as defined in any preceding embodiment (e.g., any of formulae (Ia)-(Ii) and any embodiment thereof).

In one particular embodiment, the ZnMOF is,

| Ref. No. | |
|---|---|
| ZnMOF1 | Zn₂(DAtz)(Tp)(HTp)(H₂O), form 1 (see Examples 1 and 2) |
| ZnMOF2 | Zn₂(Atz)(Tp)(H₂O) (see Example 3) |
| ZnMOF3 | Zn₂(tz)(Tp)(H₂O) (see Example 3) |
| ZnMOF4 | Zn₂(DAtz)(Tp)(HTp)(H₂O), form 2 (see Example 4) |

or a solvate or hydrate thereof, where H₂Tp is terephthalic acid (i.e,. HTp is mono-deprotonated terephthalic acid and Tp is di-deprotonated terephthalic acid), DAtz is 3,5-diamino-1,2,4-triazolate, Atz is 3-amino-1,2,4-triazolate, and tz is 1,2,4-triazolate.

Any of the preceding ZnMOF can be prepared by heating a reaction mixture comprising H₂Y, HX, a zinc salt, a base, and a solvent under conditions suitable for formation of a MOF, wherein Y and X are defined in any of the preceding formulae or embodiments.

Suitable zinc salts include zinc acetate, zinc nitrate, zinc carbonate, zinc chloride and solvates and/or hydrates thereof.

Suitable bases include tertiary amines such as trimethylamine or triethylamine and the like, and can be added to the reaction mixture in an amount suitable to adjust the pH of the mixture to be within the range from about 7 to about 9 (e.g., about 7.5). Suitable solvents include N,N-dimethylformamide, N,N′-dimethylacetamide or N,N′-diethylformamide. The presence of water should be minimized to prevent hinderance of the formation of multi-nuclear zinc clusters.

Suitable reaction conditions include heating the reaction mixture at a temperature between about 25° C. and about 200° C. for a period of time suitable to form the ZnMOF. For example, the reaction mixture can be heated at a temperature between about 50° C. and about 200° C., or between about 50° C. and about 150° C., or between about 50° C. and about 100° C., or between about 75° C. and about 100° C. As would be clear to one skilled in the art, where the reaction is heated to a temperature about the boiling point/decomposition point of the selected solvent (at standard atmospheric pressure), the reaction mixture can be placed in a sealed vessel for the duration of the heating step.

The heating at the selected temperature can continue for a period of time suitable to form the ZnMOF at the temperature selected. For example, heating can be for a period of time between about 1 minute and about 168 hours, such as between 1 hour and about 144 hours, or between about 1 hour and 120 hours, or between about 1 hour and 96 hours, or between about 1 hour and 72 hours, or between about 12 hours and about 72 hours, or between about 24 hours and about 72 hours. In certain examples, the heating can be for about an hour, or about 2 hours, or about 4 hours, or about 8 hours, or about 8 hours, or about 12 hours, or about 24 hours, or about 48 hours, or about 72 hours, or about 96 hours.

The ZnMOF will generally precipitate from the reaction mixture during the preceding reaction conditions. Upon completion of the heating step, the reaction mixture containing precipitated ZnMOF may optionally be cooled prior to filtering off the formed ZnMOF according to methods familiar to those skilled in the art. Alternatively, the ZnMOF may be collected by centrifugation of the reaction mixture followed by decantation of the supernatant. The resulting solid ZnMOF isolated by filtration or centrifugation can be optionally washed with a suitable solvent, such as, but not limited to water, acetone, methanol, ethanol, tetrahydrofuran, and mixtures thereof.

Oxygen Separation Methods

The oxygen separation process can be operated by simply bringing an oxygen-containing fluid stream into contact with the ZnMOF compositions, such as in typical temperature or pressure swing adsorption processes to generate an oxygen-reduced fluid stream. The term “fluid stream” includes both gas streams that comprise oxygen or liquid streams in which oxygen has been dissolved. The amount of oxygen in the fluid stream can be at extremely low partial pressures, typically in the range of 5 to 25% by composition. In certain embodiments, the fluid stream is a gas stream that comprises oxygen and nitrogen (e.g., air). In other embodiments, the fluid stream is a gas stream that comprises predominantly nitrogen or argon, but also a quantity of oxygen. An “oxygen-reduced fluid stream” means that the fluid stream, after the contacting with a oxygen-selective adsorbent described in this application (i.e., a ZnMOF of the application), contains at reduced oxygen-content with respect to the oxygen-content of the fluid stream prior to contacting the adsorbent. In certain embodiments, the oxygen-reduced fluid stream contains at least 5% or 10% or 20% or 30% or 40% or 50% or 60% or 70% or 80% or 90& or 95% or 98% or 99% less oxygen with respect to the fluid stream prior to contacting the adsorbent.

Specific applications for this type of process include the separation of oxygen from gas streams containing oxygen and nitrogen, such as air, and for the separation of trace amounts of oxygen from a stream. Such a process is advantageous over prior art separation processes in that solid state complexes are used which reversibly bind oxygen, thereby allowing the adsorbed oxygen to be recovered, and the sorbent (complex) to be regenerated by heating or by reducing the O₂ partial pressure over the adduct.

The O₂-selective sorbent compositions may be used in both pressure swing absorption (PSA) and temperature swing absorption (TSA) processes for the separation of air to recover oxygen or nitrogen or both.

In the pressure swing method, air (preferably dry) at ambient temperature and at pressures ranging from 1 atm to about 10 atm is passed through a column containing a fixed bed that is packed with the above solid absorbents. Oxygen is selectively absorbed by the packed bed resulting in an effluent of nearly pure nitrogen. At the end of this absorption step the bed can be rinsed and the resulting oxygenated solid in the bed can be regenerated. In this type of cycle, since oxygen is adsorbed, the bed can be rinsed with oxygen, such as by using a portion of the oxygen product produced by the cycle. This may be done by lowering the pressure of the atmosphere above the absorbent bed to about ambient conditions or by partially evacuating it to sub-ambient pressures as low as 0.05 atm (e.g., vacuum swing adsorption (VSA)).

Alternatively, oxygen desorption may be achieved by depressurizing the bed followed by purging it with some of the product nitrogen. The PSA methods described here may be used for the large scale production of oxygen or nitrogen from air, but are also useful for the removal of residual low levels of oxygen from nitrogen, argon and other gases that are inert to the absorbents.

In the temperature-swing method an oxygen-containing gas mixture, preferably a dry mixture, at from about 1 atm to 10 atm is passed through the absorbent column which results, as above, in a selective absorption of oxygen. In this case however, the regeneration of the absorbent is accomplished by heating. The desorption of O₂ may be assisted by also reducing the effective partial pressure of O₂ in the atmosphere above the absorbent by depressurization, partial evacuation to 0.1 to 0.3 atm, or by sweeping the bed with a pre-heated stream of some of the inert gas product. The latter is essentially a combined PSA/TSA process. Specific examples of PSA and TSA processes (though not with equilibrium O₂-selective sorbents) have been well described in the art. For example, see Zamora et al., Separation Science and Technology, 45: 692-699, 2010; Zhang and Stephenson, Adsorption, DOI 10.1007/s10450-013-9557-9; Grande, C. A., ISRN Chemical Engineering, Volume 2012 (2012), DOI: 10.5402/2012/982934; and Smith, A. R. et al., Fuel Processing Technology, 70, 2001, 115-134. In all of these processes the absorbent is in the solid state and can be used in various forms such as powders, as single crystals, as pellets, as a slurry, or any other suitable form for the particular application.

### DEFINITIONS

The term “alkenyl” means a straight or branched chain hydrocarbon containing from 2 to 4 carbons and containing at least one carbon-carbon double bond. Representative examples of alkenyl include, but are not limited to, ethenyl, 2-propenyl, 2-methyl-2-propenyl, and 3-butenyl.

The term “alkyl” means a straight or branched chain saturated hydrocarbon containing from 1 to 4 carbon atoms. Representative examples of alkyl include, but are not limited to, methyl, ethyl, n-propyl, iso-propyl, n-butyl, sec-butyl, iso-butyl, and tert-butyl. When an “alkyl” group is a linking group between two other moieties, then it may also be a straight or branched chain; examples include, but are not limited to —CH₂—, —CH₂CH₂—, and —CH₂CH₂CH(CH₃).

The term “alkynyl” means a straight or branched chain hydrocarbon containing from 2 to 4 carbons and containing at least one carbon-carbon triple bond. Representative examples of alkynyl include, but are not limited to, ethynyl, 2-propynyl, and 3-butynyl.

The term “aryl” means a phenyl (i.e., monocyclic aryl), or a bicyclic ring system containing at least one phenyl ring or an aromatic bicyclic ring containing only carbon atoms in the aromatic portion of the bicyclic ring system. The bicyclic aryl can be azulenyl, naphthyl, or a phenyl fused to a monocyclic cycloalkyl, a monocyclic cycloalkenyl, or a monocyclic heterocyclyl. The bicyclic aryl is attached to the parent molecular moiety through any carbon atom contained within the phenyl portion of the bicyclic system, or any carbon atom with the napthyl or azulenyl ring. The fused monocyclic cycloalkyl or monocyclic heterocyclyl portions of the bicyclic aryl are optionally substituted with one or two oxo and/or thia groups. Representative examples of the bicyclic aryls include, but are not limited to, azulenyl, naphthyl, dihydroinden-1-yl, dihydroinden-2-yl, dihydroinden-3-yl, dihydroinden-4-yl, 2,3-dihydroindol-4-yl, 2,3-dihydroindol-5-yl, 2,3-dihydroindol-6-yl, 2,3-dihydroindol-7-yl, inden-1-yl, inden-2-yl, inden-3-yl, inden-4-yl, dihydronaphthalen-2-yl, dihydronaphthalen-3-yl, dihydronaphthalen-4-yl, dihydronaphthalen-1-yl, 5,6,7,8-tetrahydronaphthalen-1-yl, 5,6,7,8-tetrahydronaphthalen-2-yl, 2,3-dihydrobenzofuran-4-yl, 2,3-dihydrobenzofuran-5-yl, 2,3-dihydrobenzofuran-6-yl, 2,3-dihydrobenzofuran-7-yl, benzo[d][1,3]dioxol-4-yl, benzo[d][1,3]dioxol-5-yl, 2H-chromen-2-on-5-yl, 2H-chromen-2-on-6-yl, 2H-chromen-2-on-7-yl, 2H-chromen-2-on-8-yl, isoindoline-1,3-dion-4-yl, isoindoline-1,3-dion-5-yl, inden-1-on-4-yl, inden-1-on-5-yl, inden-1-on-6-yl, inden-1-on-7-yl, 2,3-dihydrobenzo[b][1,4]dioxan-5-yl, 2,3-dihydrobenzo[b][1,4]dioxan-6-yl, 2H-benzo[b][1,4]oxazin-3(4H)-on-5-yl, 2H-benzo[b][1,4]oxazin-3(4H)-on-6-yl, 2H-benzo[b][1,4]oxazin-3(4H)-on-7-yl, 2H-benzo[b][1,4]oxazin-3(4H)-on-8-yl, benzo[d]oxazin-2(3H)-on-5-yl, benzo[d]oxazin-2(3H)-on-6-yl, benzo[d]oxazin-2(3H)-on-7-yl, benzo[d]oxazin-2(3H)-on-8-yl, quinazolin-4(3H)-on-5-yl, quinazolin-4(3H)-on-6-yl, quinazolin-4(3H)-on-7-yl, quinazolin-4(3H)-on-8-yl, quinoxalin-2(1H)-on-5-yl, quinoxalin-2(1H)-on-6-yl, quinoxalin-2(1H)-on-7-yl, quinoxalin-2(1H)-on-8-yl, benzo[d]thiazol-2(3H)-on-4-yl, benzo[d]thiazol-2(3H)-on-5-yl, benzo[d]thiazol-2(3H)-on-6-yl, and, benzo[d]thiazol-2(3H)-on-7-yl. In certain embodiments, the bicyclic aryl is (i) naphthyl or (ii) a phenyl ring fused to either a 5 or 6 membered monocyclic cycloalkyl, a 5 or 6 membered monocyclic cycloalkenyl, or a 5 or 6 membered monocyclic heterocyclyl, wherein the fused cycloalkyl, cycloalkenyl, and heterocyclyl groups are optionally substituted with one or two groups which are independently oxo or thia.

The terms “cyano” and “nitrile” mean a —CN group.

The term “cycloalkyl” means a monocyclic or a bicyclic cycloalkyl ring system. Monocyclic ring systems are cyclic hydrocarbon groups containing from 3 to 8 carbon atoms, where such groups can be saturated or unsaturated, but not aromatic. In certain embodiments, cycloalkyl groups are fully saturated. Examples of monocyclic cycloalkyls include cyclopropyl, cyclobutyl, cyclopentyl, cyclopentenyl, cyclohexyl, cyclohexenyl, cycloheptyl, and cyclooctyl. Bicyclic cycloalkyl ring systems are bridged monocyclic rings or fused bicyclic rings. Bridged monocyclic rings contain a monocyclic cycloalkyl ring where two non-adjacent carbon atoms of the monocyclic ring are linked by an alkylene bridge of between one and three additional carbon atoms (i.e., a bridging group of the form —(CH2)w-, where w is 1, 2, or 3). Representative examples of bicyclic ring systems include, but are not limited to, bicyclo[3.1.1]heptane, bicyclo[2.2.1]heptane, bicyclo[2.2.2]octane, bicyclo[3.2.2]nonane, bicyclo[3.3.1]nonane, and bicyclo[4.2.1]nonane. Fused bicyclic cycloalkyl ring systems contain a monocyclic cycloalkyl ring fused to either a phenyl, a monocyclic cycloalkyl, a monocyclic cycloalkenyl, a monocyclic heterocyclyl, or a monocyclic heteroaryl. The bridged or fused bicyclic cycloalkyl is attached to the parent molecular moiety through any carbon atom contained within the monocyclic cycloalkyl ring. Cycloalkyl groups are optionally substituted with one or two groups which are independently oxo or thia. In certain embodiments, the fused bicyclic cycloalkyl is a 5 or 6 membered monocyclic cycloalkyl ring fused to either a phenyl ring, a 5 or 6 membered monocyclic cycloalkyl, a 5 or 6 membered monocyclic cycloalkenyl, a 5 or 6 membered monocyclic heterocyclyl, or a 5 or 6 membered monocyclic heteroaryl, wherein the fused bicyclic cycloalkyl is optionally substituted by one or two groups which are independently oxo or thia.

“Cycloalkenyl” refers to a monocyclic or a bicyclic cycloalkenyl ring system. Monocyclic ring systems are cyclic hydrocarbon groups containing from 3 to 8 carbon atoms, where such groups are unsaturated (i.e., containing at least one annular carbon-carbon double bond), but not aromatic. Examples of monocyclic ring systems include cyclopentenyl and cyclohexenyl.

Bicyclic cycloalkenyl rings are bridged monocyclic rings or fused bicyclic rings. Bridged monocyclic rings contain a monocyclic cycloalkenyl ring where two non-adjacent carbon atoms of the monocyclic ring are linked by an alkylene bridge of between one and three additional carbon atoms (i.e., a bridging group of the form —(CH2)w-, where w is 1, 2, or 3). Representative examples of bicyclic cycloalkenyls include, but are not limited to, norbornenyl and bicyclo[2.2.2]oct-2-enyl. Fused bicyclic cycloalkenyl ring systems contain a monocyclic cycloalkenyl ring fused to either a phenyl, a monocyclic cycloalkyl, a monocyclic cycloalkenyl, a monocyclic heterocyclyl, or a monocyclic heteroaryl. The bridged or fused bicyclic cycloalkenyl is attached to the parent molecular moiety through any carbon atom contained within the monocyclic cycloalkenyl ring. Cycloalkenyl groups are optionally substituted with one or two groups which are independently oxo or thia.

The term “halo” or “halogen” means —Cl, —Br, —I or —F.

The term “haloalkyl” means at least one halogen, as defined above, appended to the parent molecular moiety through an alkyl group, as defined herein. Representative examples of haloalkyl include, but are not limited to, chloromethyl, fluoromethyl, 2-fluoroethyl, difluoromethyl, trifluoromethyl, pentafluoroethyl, and 2-chloro-3-fluorobutyl.

The term “heteroaryl” means a monocyclic heteroaryl or a bicyclic ring system containing at least one heteroaromatic ring. The monocyclic heteroaryl can be a 5 or 6 membered ring. The 5 membered ring consists of two double bonds and one, two, three or four nitrogen atoms and/or one oxygen or sulfur atom. The 6 membered ring consists of three double bonds and one, two, three or four nitrogen atoms. The 5 or 6 membered heteroaryl is connected to the parent molecular moiety through any carbon atom or any nitrogen atom contained within the heteroaryl. Representative examples of monocyclic heteroaryl include, but are not limited to, furyl, imidazolyl, isoxazolyl, isothiazolyl, oxadiazolyl, oxazolyl, pyridinyl, pyridazinyl, pyrimidinyl, pyrazinyl, pyrazolyl, pyrrolyl, tetrazolyl, thiadiazolyl, thiazolyl, thienyl, triazolyl, and triazinyl. The bicyclic heteroaryl consists of a monocyclic heteroaryl fused to a phenyl, a monocyclic cycloalkyl, a monocyclic cycloalkenyl, a monocyclic heterocyclyl, or a monocyclic heteroaryl. The fused cycloalkyl or heterocyclyl portion of the bicyclic heteroaryl group is optionally substituted with one or two groups which are independently oxo or thia. When the bicyclic heteroaryl contains a fused cycloalkyl, cycloalkenyl, or heterocyclyl ring, then the bicyclic heteroaryl group is connected to the parent molecular moiety through any carbon or nitrogen atom contained within the monocyclic heteroaryl portion of the bicyclic ring system. When the bicyclic heteroaryl is a monocyclic heteroaryl fused to a phenyl ring or a monocyclic heteroaryl, then the bicyclic heteroaryl group is connected to the parent molecular moiety through any carbon atom or nitrogen atom within the bicyclic ring system. Representative examples of bicyclic heteroaryl include, but are not limited to, benzimidazolyl, benzofuranyl, benzothienyl, benzoxadiazolyl, benzoxathiadiazolyl, benzothiazolyl, cinnolinyl, 5,6-dihydroquinolin-2-yl, 5,6-dihydroisoquinolin-1-yl, furopyridinyl, indazolyl, indolyl, isoquinolinyl, naphthyridinyl, quinolinyl, purinyl, 5,6,7,8-tetrahydroquinolin-2-yl, 5,6,7,8-tetrahydroquinolin-3-yl, 5,6,7,8-tetrahydroquinolin-4-yl, 5,6,7,8-tetrahydroisoquinolin-1-yl, thienopyridinyl, 4,5,6,7-tetrahydrobenzo[c][1,2,5]oxadiazolyl, and 6,7-dihydrobenzo[c][1,2,5]oxadiazol-4(5H)-onyl. In certain embodiments, the fused bicyclic heteroaryl is a 5 or 6 membered monocyclic heteroaryl ring fused to either a phenyl ring, a 5 or 6 membered monocyclic cycloalkyl, a 5 or 6 membered monocyclic cycloalkenyl, a 5 or 6 membered monocyclic heterocyclyl, or a 5 or 6 membered monocyclic heteroaryl, wherein the fused cycloalkyl, cycloalkenyl, and heterocyclyl groups are optionally substituted with one or two groups which are independently oxo or thia.

The term “heterocyclyl” means a monocyclic heterocycle or a bicyclic heterocycle. The monocyclic heterocycle is a 3, 4, 5, 6, 7, or 8 membered ring containing at least one heteroatom independently selected from the group consisting of O, N, and S where the ring is saturated or unsaturated, but not aromatic. The 3 or 4 membered ring contains 1 heteroatom selected from the group consisting of O, N and S. The 5 membered ring can contain zero or one double bond and one, two or three heteroatoms selected from the group consisting of O, N and S. The 6, 7, or 8 membered ring contains zero, one or two double bonds and one, two or three heteroatoms selected from the group consisting of O, N and S. The monocyclic heterocycle is connected to the parent molecular moiety through any carbon atom or any nitrogen atom contained within the monocyclic heterocycle. Representative examples of monocyclic heterocycle include, but are not limited to, azetidinyl, azepanyl, aziridinyl, diazepanyl, 1,3-dioxanyl, 1,3-dioxolanyl, 1,3-dithiolanyl, 1,3-dithianyl, imidazolinyl, imidazolidinyl, isothiazolinyl, isothiazolidinyl, isoxazolinyl, isoxazolidinyl, morpholinyl, oxadiazolinyl, oxadiazolidinyl, oxazolinyl, oxazolidinyl, piperazinyl, piperidinyl, pyranyl, pyrazolinyl, pyrazolidinyl, pyrrolinyl, pyrrolidinyl, tetrahydrofuranyl, tetrahydrothienyl, thiadiazolinyl, thiadiazolidinyl, thiazolinyl, thiazolidinyl, thiomorpholinyl, 1,1-dioxidothiomorpholinyl (thiomorpholine sulfone), thiopyranyl, and trithianyl. The bicyclic heterocycle is a monocyclic heterocycle fused to either a phenyl, a monocyclic cycloalkyl, a monocyclic cycloalkenyl, a monocyclic heterocycle, or a monocyclic heteroaryl. The bicyclic heterocycle is connected to the parent molecular moiety through any carbon atom or any nitrogen atom contained within the monocyclic heterocycle portion of the bicyclic ring system. Representative examples of bicyclic heterocyclyls include, but are not limited to, 2,3-dihydrobenzofuran-2-yl, 2,3-dihydrobenzofuran-3-yl, indolin-1-yl, indolin-2-yl, indolin-3-yl, 2,3-dihydrobenzothien-2-yl, decahydroquinolinyl, decahydroisoquinolinyl, octahydro-1H-indolyl, and octahydrobenzofuranyl. Heterocyclyl groups are optionally substituted with one or two groups which are independently oxo or thia. In certain embodiments, the bicyclic heterocyclyl is a 5 or 6 membered monocyclic heterocyclyl ring fused to phenyl ring, a 5 or 6 membered monocyclic cycloalkyl, a 5 or 6 membered monocyclic cycloalkenyl, a 5 or 6 membered monocyclic heterocyclyl, or a 5 or 6 membered monocyclic heteroaryl, wherein the bicyclic heterocyclyl is optionally substituted by one or two groups which are independently oxo or thia.

The term “nitro” means a —NO₂ group.

The term “oxo” means a ═O group.

The term “saturated” means the referenced chemical structure does not contain any multiple carbon-carbon bonds. For example, a saturated cycloalkyl group as defined herein includes cyclohexyl, cyclopropyl, and the like.

The term “thia” means a ═S group.

The term “unsaturated” means the referenced chemical structure contains at least one multiple carbon-carbon bond, but is not aromatic. For example, an unsaturated cycloalkyl group as defined herein includes cyclohexenyl, cyclopentenyl, cyclohexadienyl, and the like.

Terms may be preceded and/or followed by a single dash to indicate the bond order of the bond between the named substituent and its parent moiety and indicates a single bond. In the absence of a single dash it is understood that a single bond is formed between the substituent and its parent moiety; further, substituents are intended to be read “left to right” unless a dash indicates otherwise. For example, C₁-C₆alkoxy and —OC₁-C₆alkyl indicate the same functionality. Further, certain terms herein may be used as both monovalent and divalent linking radicals as would be familiar to those skilled in the art, and by their presentation linking between two other moieties. For example, an alkyl group can be both a monovalent radical or divalent radical; in the latter case, it would be apparent to one skilled in the art that an additional hydrogen atom is removed from a monovalent alkyl radical to provide a suitable divalent moiety.

While specific embodiments have been described in detail, those with ordinary skill in the art will appreciate that various modifications and alternatives to those details could be developed in light of the overall teachings of the disclosure. Accordingly, the particular arrangements disclosed are meant to be illustrative only and not limiting as to the scope of the invention, which is to be given the full breadth of the appended claims, and any and all equivalents thereof. Unless otherwise defined, all technical and scientific terms used herein have the same meaning as commonly understood by one of ordinary skill in the art to which this invention pertains. All references mentioned herein, including publications, patent applications, and patents, are incorporated by reference in their entirety. In addition, the materials, methods, and examples herein are only illustrative and not intended to be limiting.

### EXAMPLES

### Example 1

### Synthesis of ZnMOF1 (Zn₂(DAtz)(Tp)(HTp)(H₂O), Form 1)

In a typical synthesis, about 0.545 g of zinc acetate dihydrate (2.5 mmol) was dissolved in 25 mL N,N-dimethylformamide (DMF). To this 0.124 g of 3,5-diamino-1,2,4-triazole (1.25 mmol) was added, followed by 0.518 g of terepthalic acid (3.125 mmol). The pH was adjusted to 7.5 using triethylamine. Contents were stirred for 30 minutes before being sealed in a teflon-lined autoclave. The solvothermal reaction was carried out at 90° C. for 72 hrs. A white crystalline solid was obtained which was washed with copious amounts of water, methanol, tetrahydrofuran (THF) and acetone.

### Example 2

### Characterization of ZnMOF1

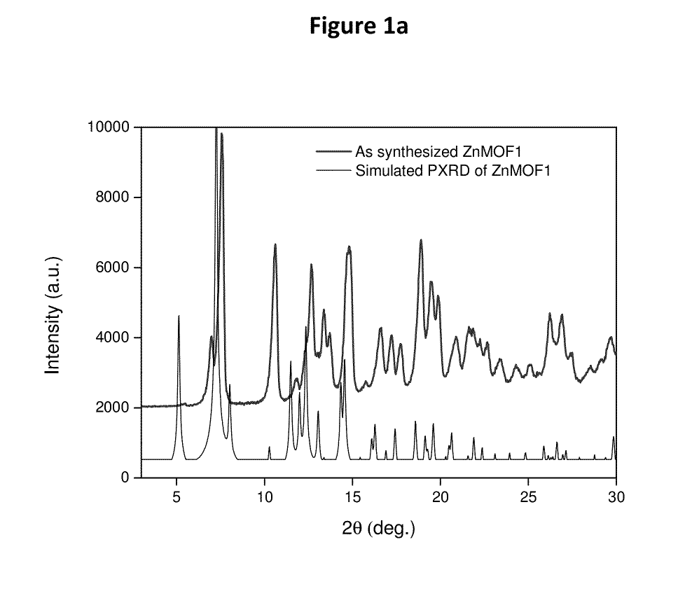

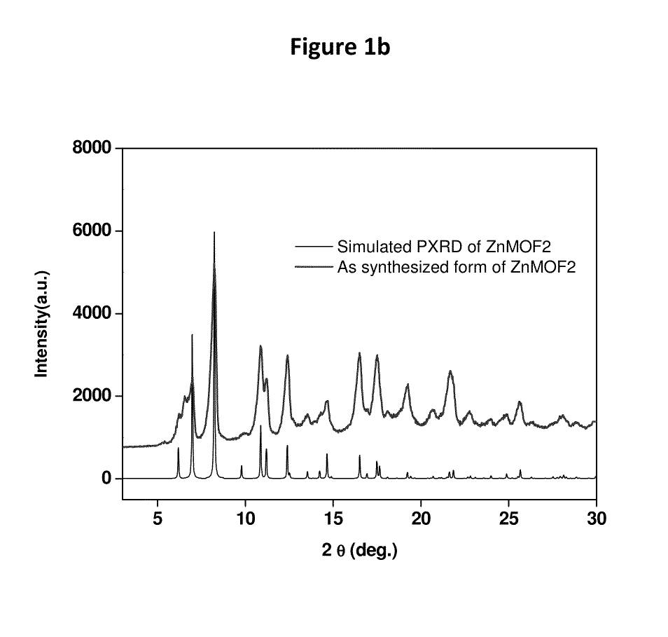

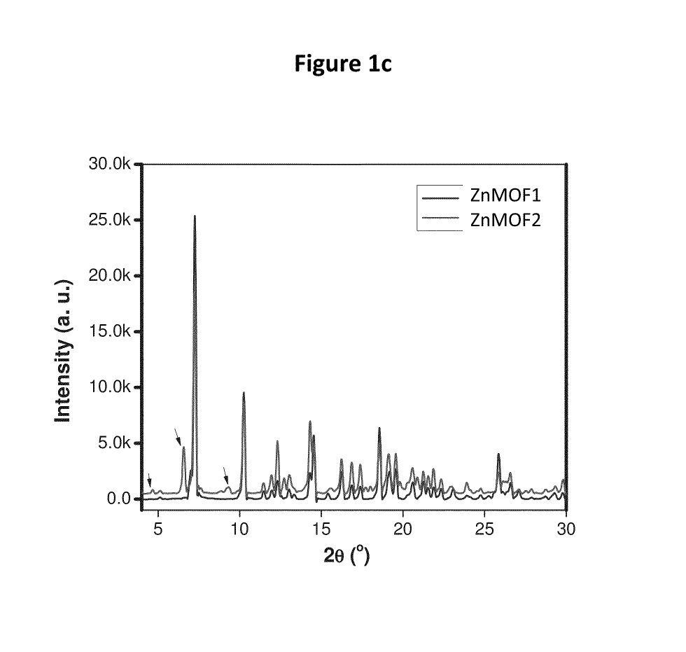

Powder X-ray diffraction pattern of ZnMOF1 indicated the presence of a pure phase. See FIG. 1a, Table 1.

FIG. 1a shows the comparison of the powder x-ray diffraction (PXRD) patterns of the as synthesized phase of ZnMOF1 (top trace) its corresponding simulated PXRD (bottom trace) patterns generated from the single crystal data. Note that in ZnMOF1 case, all the peaks are slightly right shifted and this is due to height offset during the sample preparation.

TABLE 1
ZnMOF1 PXRD characteristic peaks

| | | |
|---|---|---|
| 2-theta (deg) | 2-theta (deg) | 2-theta (deg) |

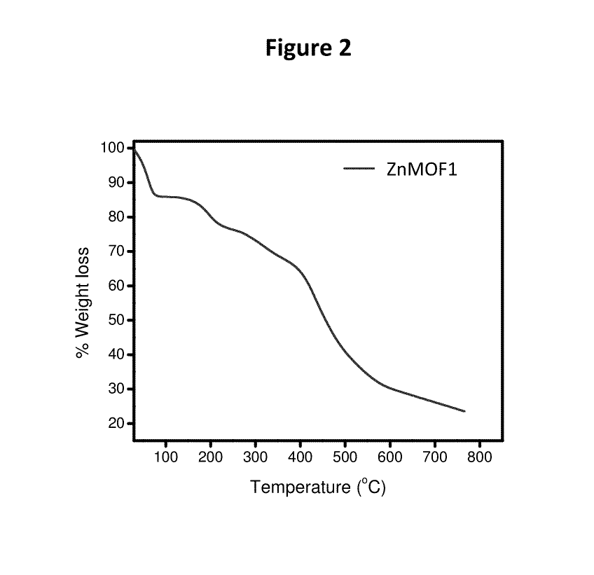

Thermogravemetric (TGA) studies showed about 30% solvent loss from room temperature to 320° C., which could be attributed to the loss of water and DMF from the pores. See FIG. 2. There is about 30% weight loss due to the solvent and the compound could be stable up to ^{˜}400° C. Note subtle activation procedures would be carried out to maintain smooth solvent loss and retain the porosity at these high temperatures. The solvent free sample shows a stability window in the range of 320° C. to 400° C. However, this could be improved drastically by suitable activation procedures which involves the exchange of as made samples with solvents such as methanol or acetone or a mixture of these solvent or isopropanol.

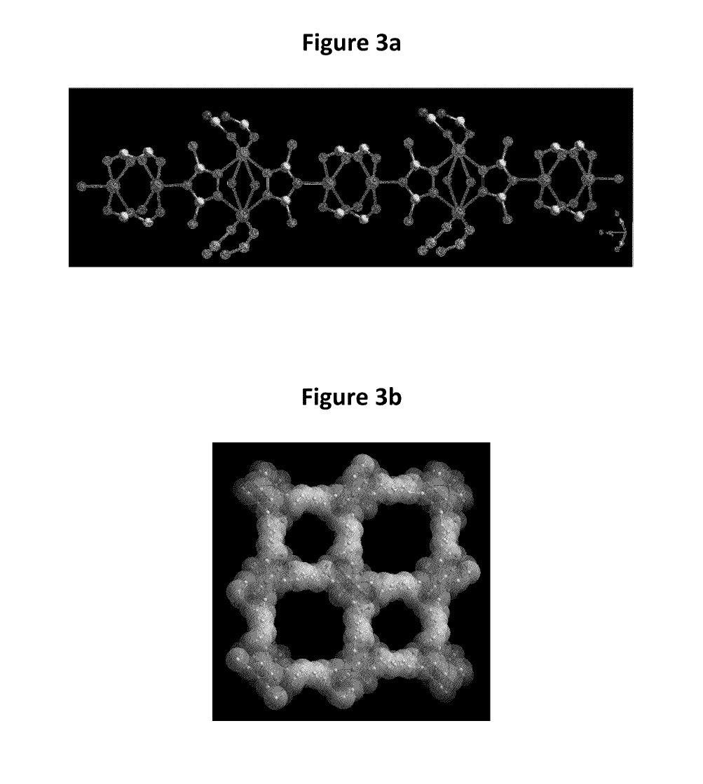

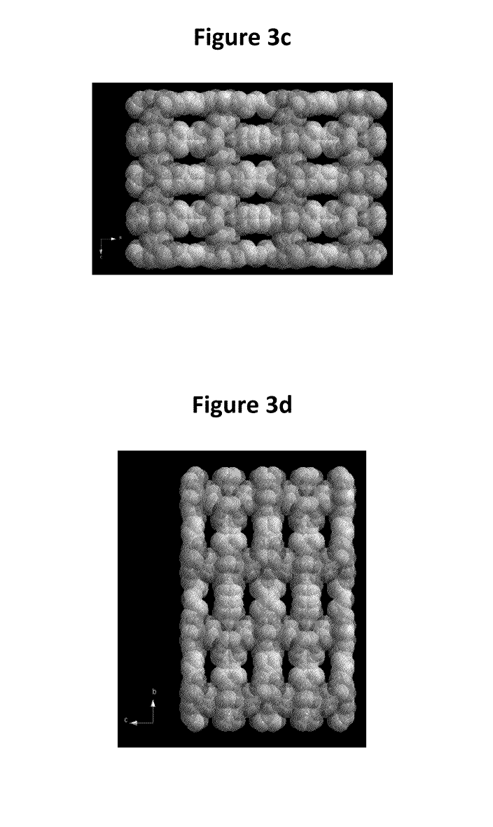

The structure of ZnMOF1 is made up of the linking of Zn₂O₄ type paddle wheel clusters built from the Zn and terephthalate units by the dimeric Zn₂(DAtz) type clusters (FIG. 3a). These run as a chain along all three orthogonal directions to generate a cubic three-dimensional framework that resembles the topology of the MOF-5. In particular, ZnMOF1 contains Zn centers having a heavily distorded octahedral geometry arising from two μ1-dicarboxylates and two bridging μ2-triazolate nitrogens and two bridging water molecules. (FIG. 3a). FIG. 3a illustrates one-dimensional chains in ZnMOF1 showing the orientation of the monodentately linking terephthalate and bridging water molecules; these tetrahedrally disposed terephthalates appear to give rise to uniform channels in the three dimensional structure of ZnMOF1.

Without being limited by theory, it is believed that the presence of bridging water and flexible monodentately linking terephthalate units give rise to uniform channels in the three dimensional structure.

It is interesting that the building the dimeric Zn-azolate cluster found in a range of Zinc-azolate-dicarboxylate frameworks. To our knowledge, both the latter clusters are less susceptible to hydrolyses by moisture compared to the oxo-clusters in MOF-5 type structures. By assembling these stable clusters in three-dimensions and generating the MOF-5 topology ZnMOF1 enhances the porosity and stability simultaneously.

One recent report (see Ling et al., Chem. Communications 2011, 47, 7197) of a 3,5-dimethyl-1,2,4-triazolate and terephthalate Zn-MOF that has a three-dimensional topology comparable to the ZnMOF1. This has been investigated entirely for the hydrophobic character and separation arising chiefly from the methyl lining of the pores coming from the 3,5-dimethyl-1,2,4-triazolate ligands. This “methyltriazolate MOF” appears to have uniform IIA pores along the c-direction and appears to be considerably dense along other orthogonal directions.

On the contrary, owing to higher symmetry of the framework and subtle structural variations, there are two different pores along the c-direction[13.5 Å and 8.5 Å, not factoring the van der Waal radii] of ZnMOF1 (see FIG. 3b) which clearly indicates that ZnMOF1 does not possess the same topology as the methyltriazolate MOF. In particular, FIG. 3b illustrates the three-dimensional structure of ZnMOF1 having two types of channels (^{˜}11.5 and ^{˜}5.5 Å) along c-axis.

This topological difference is also reflected in the crystallographic symmetry parameters. In addition, the ZnMOF1 has narrow slit shaped pores along the a and b-directions. FIG. 3c illustrates the slit shaped pores (about 3 Å×5.5 Å) along in ZnMOF1 the a-direction. These dimensions are comparable to those in zeolites and gas molecules could diffuse through. The slit shaped pores could offer selectivity towards specific gases. FIG. 3d illustrates the slit shaped pores (about 3 Å×5.5 Å, factoring vander Waal radii) along in ZnMOF1 the b-directions. ZnMOF1 porosity along all multiple directions which provides solvent accessible voids (^{˜}65%, calculated using PLATON). These dimensions are comparable to those in zeolites and gas molecules could diffuse through.

Thus, ZnMOF1 is truly three-dimensionally porous as compared to the methyltriazolate MOF. This can maximize the gas adsorption in ZnMOF1 as compared to the methyltriazolate MOF. Without being limited by theory, it is further believed that the incorporated amino groups in ZnMOF1-ZnMOF4 (infra) can increase the polarizing character of the pore, which may have implications in gas uptake and selectivity.

### Example 3

### Isostructural ZnMOFs

ZnMOFs wherein the 3,5-diamino-1,2,4-triazole is replaced by 3-amino-1,2,4-triazole (ZnMOF2) or 1,2,4-triazole (ZnMOF3) can be made by increasing the amount of solvent in the synthesis and changing the pH to a slightly higher value as compared to the synthesis conditions of Example 1.

FIG. 1b shows the comparison of the PXRD patterns of the as synthesized phase of ZnMOF2 (top trace) with its corresponding simulated PXRD (bottom trace) patterns generated from the single crystal data.

TABLE 2
ZnMOF2 PXRD characteristic peaks

| | | |
|---|---|---|
| 2-theta (deg) | 2-theta (deg) | 2-theta (deg) |

FIG. 1c compares the PXRD of (a) diaminotriazolate ZnMOF1 and (b) aminotriazolate ZnMOF2. Note: Arrows indicate a minor impurity phase in ZnMOF2. The impurity phase has been isolated as a pure phase but using diaminotriazole, as described in Example 4.

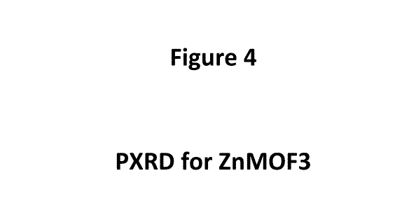

FIG. 4 shows the PXRD pattern of the as synthesized phase of ZnMOF3.

TABLE 3
ZnMOF3 PXRD characteristic peaks

| | | |
|---|---|---|
| 2-theta (deg) | 2-theta (deg) | 2-theta (deg) |

### Example 4

### ZnMOF4 (Zn₂(DAtz)(Tp)(HTp)(H₂O), Form 2)

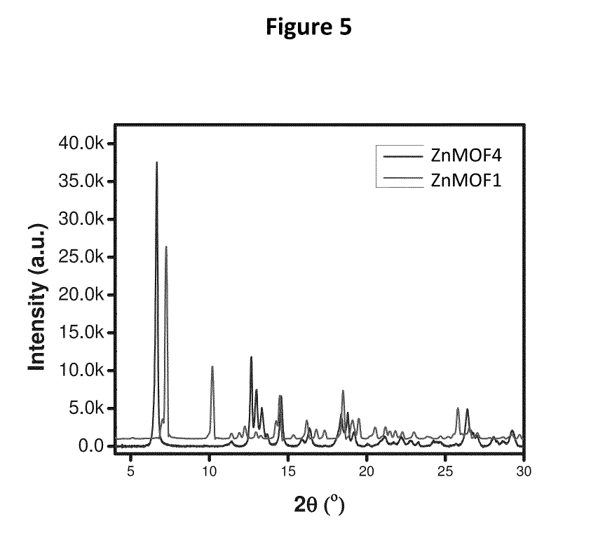

Changing the synthesis condition of ZnMOF1 via careful tuning yields another interesting phase (ZnMOF4) that has been isolated as a pure compound as indicated by the PXRD patterns. FIG. 5 shows the PXRD of ZnMOF4.

TABLE 4
ZnMOF4 PXRD characteristic peaks

| | | |
|---|---|---|
| 2-theta (deg) | 2-theta (deg) | 2-theta (deg) |

| | |
|---|---|
| 2-theta (deg) | 2-theta (deg) |

Powder X-ray diffraction (PXRD) comparisons of the diaminotriazolate ZnMOF1 and the minor impurity phase in ZnMOF2, which has been synthesized as a pure phase here (ZnMOF4). Note: Though ZnMOF4 was an impurity phase in the aminotriazolate phase, it has been isolated as a pure phase using diaminotriazole. It is interesting to note that there is good resemblance between ZnMOF1 and ZnMOF4 as observed from the PXRDs.

### Example 5

### Nitrogen Adsorption for ZnMOF1 and ZnMOF2

Adsorption experiments for nitrogen and oxygen were carried out on a Quantachrome iQ-MP gas adsorption analyzer (Quantachrome Instruments, Boynton Beach, Fla.) fitted with a low pressure transducer suitable for micropore determinations. Samples were activated by soaking in solvents (typically methanol or acetone or a mixture of both) for time periods in the range of 12 hrs to 72 hrs and then were evacuated on the degas port of the adsorption analyzer at 85 C before gas adsorptions (N₂ at 77K or CO₂ at 273 K or O₂ at 298K) were carried out on them

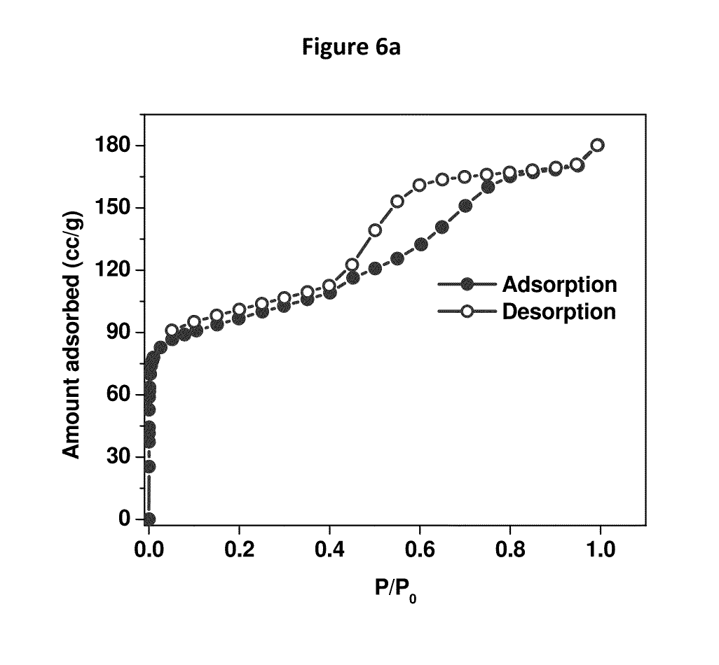

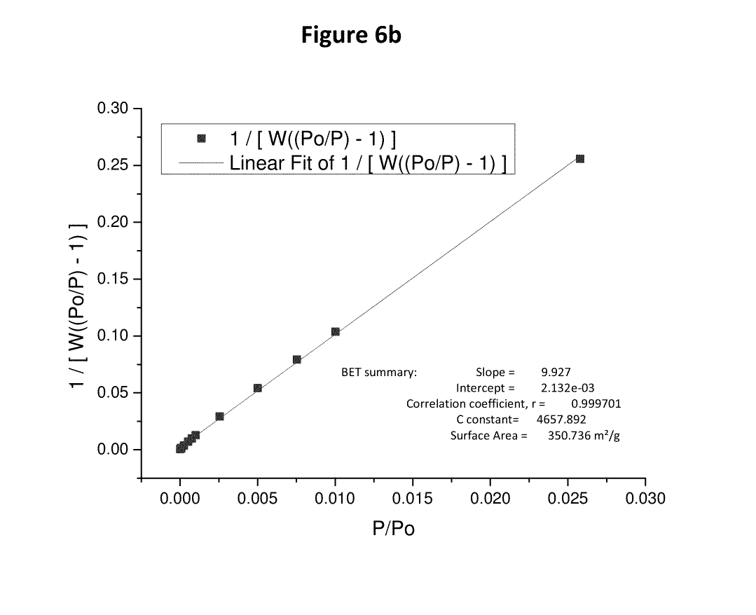

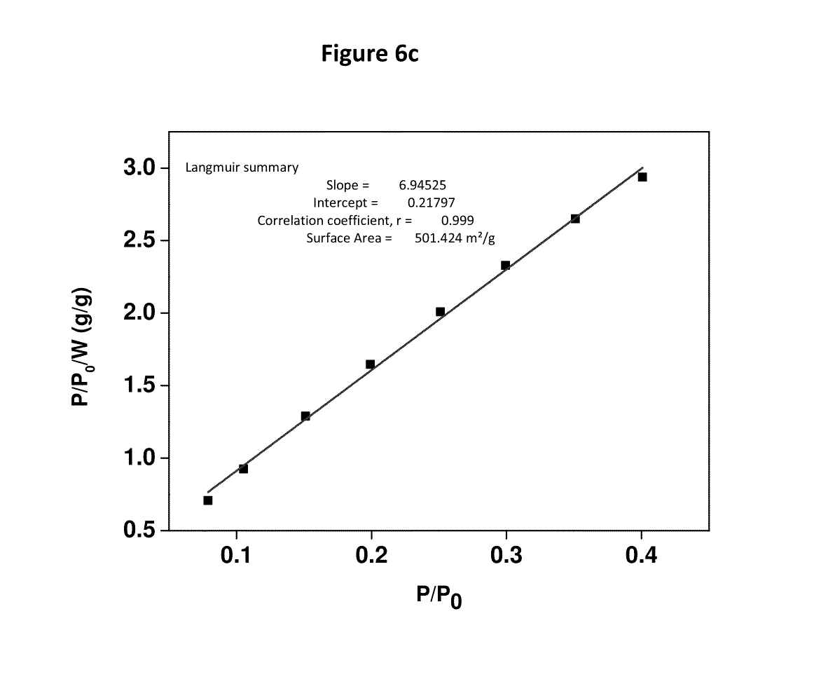

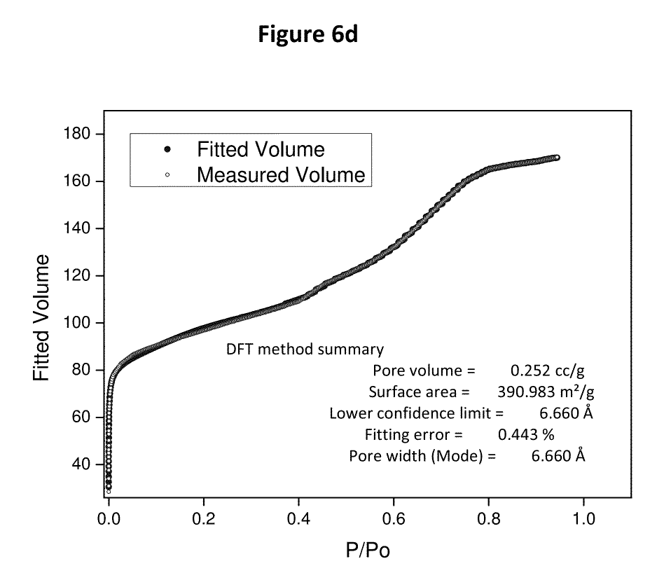

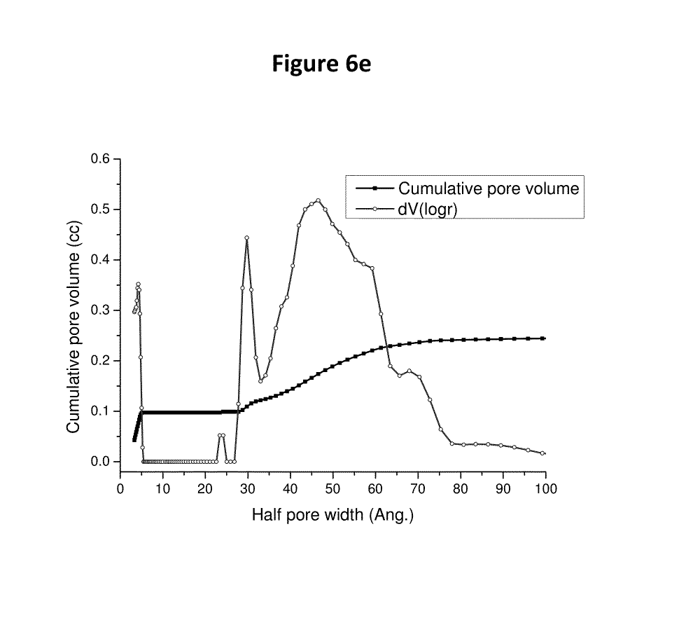

FIG. 6a shows the measured Nitrogen adsorption on ZnMOF1 carried out at 77K. Note the presence of hysteresis in the range of P/P₀=0.8 to 0.4. The presence of an abrupt uptake at low partial pressures (P/P₀=0 to 0.03) indicates the presence of well-defined micropores and the hysteresis indicates the presence of significant mesoporosity. Such multi-dimensional pore characteristic in MOF is rare and can be of advantage in exhibiting good gas kinetics in a dynamic gas adsorption.

FIG. 6b shows a BET isotherm area model fit for the adsorption data of FIG. 6a, giving a surface area of 350.736 m²/g with r=0.999701.

FIG. 6c shows a Langmuir isotherm model fit for the adsorption data of FIG. 6a, giving a surface area of 501.424 m²/g with r=0.999.

FIG. 6d shows the DFT modeling of ZnMOF1 using the 77K N₂ adsorption data. A QSDFT adsorption model considering a combination of cylindrical/spherical/slit pores was used based on the single crystal structure. The fit obtained appears good (error: 0.443%), hence was further analyzed to derive the pore size distribution.

FIG. 6e shows the pore size distribution present in ZnMOF1 as calculated based on the DFT model. The dV(log r), wherein ‘r’ represents the radius of the pores, indicate the presence of a multitudes of pores in this material. There is significant amount of micropores with a dimension of 8.5 Å; and a cluster of mesopores ranging from 60 Å to 100 Å. This is in agreement with the isotherm. Such large pores make this material show comparably higher capacity for O₂ than ZnMOF2, as described below, but with lowered selectivity.

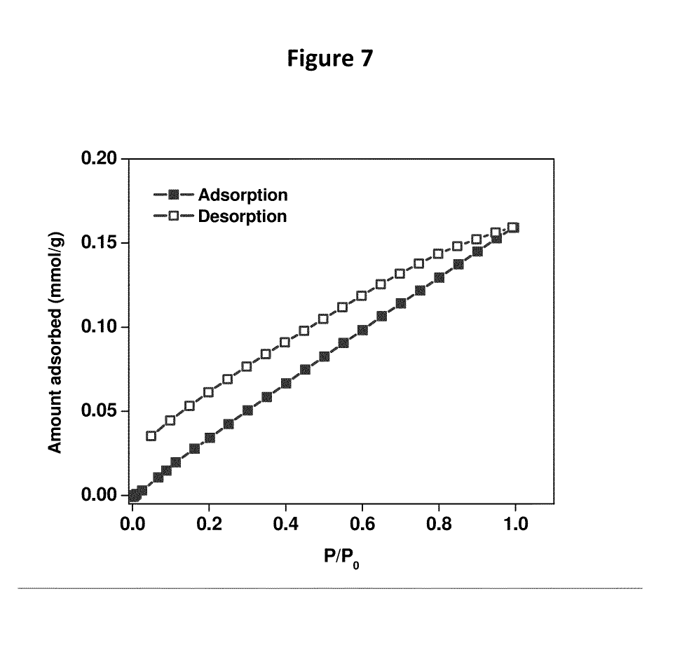

FIG. 7 shows the measured O₂ adsorption on ZnMOF1 at 30° C. The uptake is reasonable, however the selectivity towards O₂ over N₂ was not sufficient in this material as observed from the TGA and column studies.

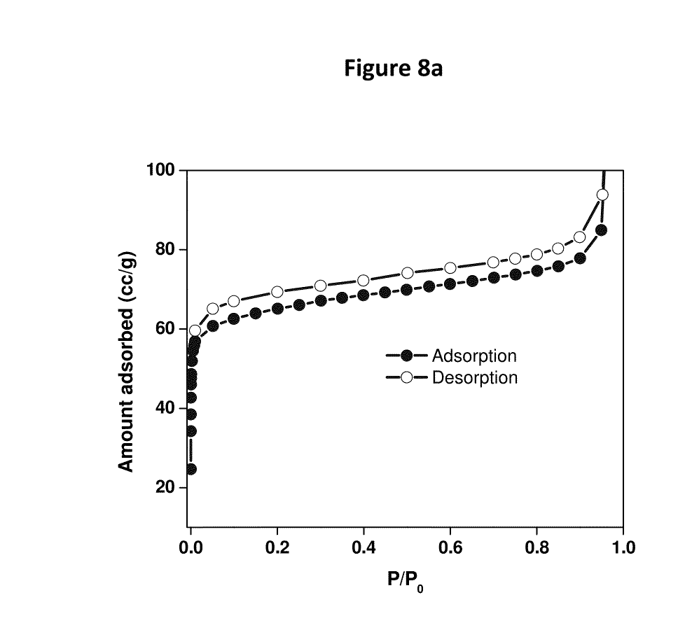

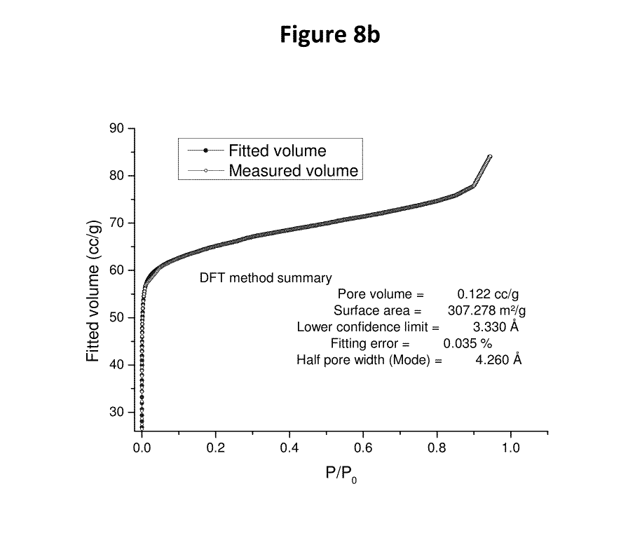

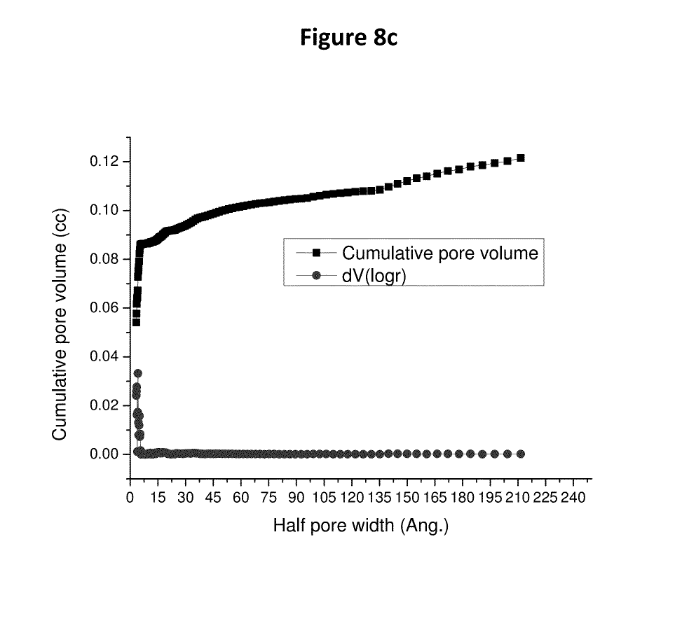

FIG. 8a shows the measured N₂ adsorption on ZnMOF2 at 77K on isopropanol activated sample. Unlike ZnMOF1 this does not seem to have any mesoporous character. This could explain the improved selectivity towards O₂ arising from ZnMOF2 compared to ZnMOF1. O₂ selectivity was determined from TGA and column set-ups.

FIG. 8b shows the DFT modeling of ZnMOF2 using the 77K N₂ adsorption data. A QSDFT adsorption model considering a combination of cylindrical/slit pores was used based on the single crystal structure. The fit obtained appears good (error: 0.035%), hence was further analyzed to derive the pore size distribution.

FIG. 8c shows the pore size distribution present in ZnMOF2 as calculated based on the DFT model. The dV(log r), wherein ‘r’ represents the radius of the pores, indicate the presence of uniform micropores with 8.0 Å dimension. This is in agreement with the isotherm. Such uniform micropores make this material show comparably higher selectivity for O₂ than ZnMOF1 but with lowered capacity.

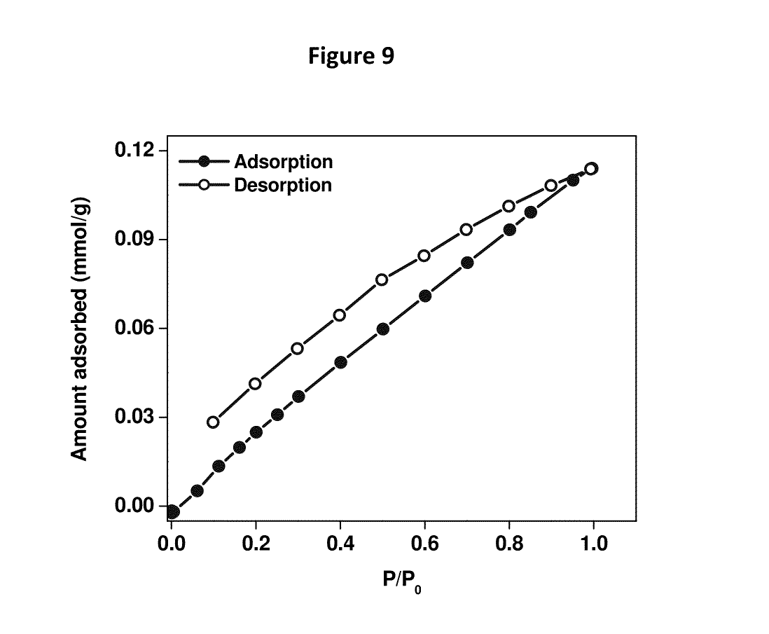

FIG. 9 shows the O₂ adsorption on ZnMOF1 at 10° C. The uptake is appreciable, and has better selectivity towards O₂ over N₂ as observed from the TGA and column studies.

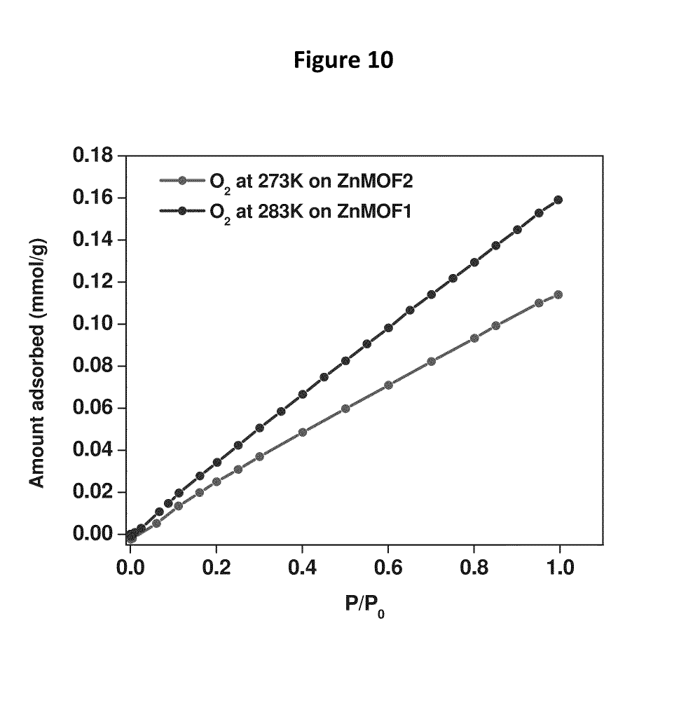

FIG. 10 shows the comparison of the O₂ adsorption on ZnMOF1 (30° C.) and ZnMOF2 (10° C.). The ZnMOF1 does have a higher capacity even at 30° C. as compared to the O₂ uptake shown by ZnMOF2 at 10° C. Without being limited by theory, it is believed that this higher capacity of ZnMOF1 may be due to the presence of well-defined mesopores which are absent in ZnMOF2. However, dynamic O₂/N₂ separation studies done on TGA and a fixed bed column set-up does indicate superior selectivity towards O₂ from ZnMOF2.

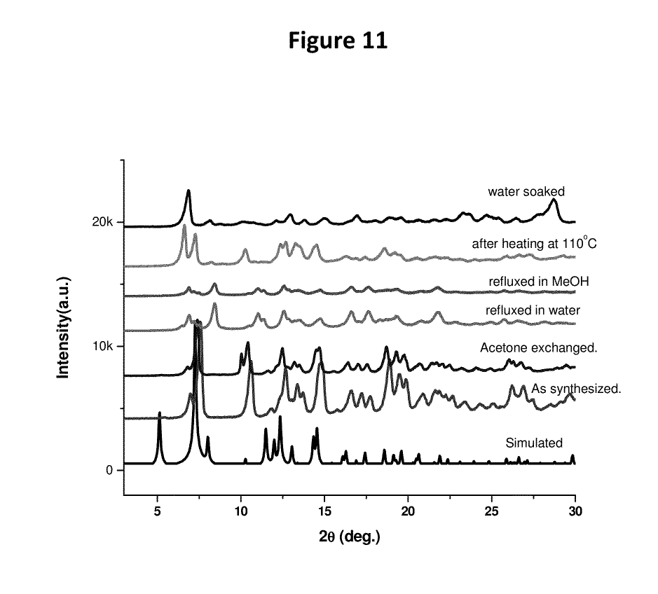

FIG. 11 shows the PXRDs corresponding to ZnMOF1 following different solvent and solvent plus heat treatments. It is evident from these PXRDs that the material undergoes significant degradation in crystallinity when exposed to water at room temperature. On the other hand, when refluxed in water or methanol it transforms to a new phase. Heating of the ZnMOF1 in dry powder form at 110° C. lowers the crystallinity to some extent. Treating ZnMOF1 with acetone seems to maintain the crystallinity of the material. Though the PXRD is not presented, it was observed that soaking the sample in methanol at room temperature renders the material in a form comparable to what is shown in acetone treatment.

We claim:

1. A method for removing oxygen from a fluid stream comprising oxygen and at least one other component comprising,
contacting the fluid stream with a Zn-metal organic framework (ZnMOF) that is capable of selectively and reversibly binding oxygen under conditions suitable to yield an oxygen-reduced fluid stream.

2. The method of claim 1, wherein the ZnMOF has an average pore size between 6 Å and 25 Å.

3. The method of claim 1, wherein the ZnMOF has an average pore size between 8 Å and 16 Å.

4. The method of claim 1, wherein the conditions suitable to yield an oxygen-reduced fluid stream is a pressure swing adsorption process.

5. The method of claim 1, wherein the conditions suitable to yield an oxygen-reduced fluid stream is a thermal swing adsorption process.

6. The method of claim 1, wherein the fluid stream is a gas stream comprising oxygen and nitrogen.

7. The method of claim 1, wherein the fluid stream is a gas stream comprising argon and oxygen.

8. The method of claim 6, wherein the fluid stream is air and the oxygen-reduced fluid stream is a nitrogen-enriched product stream.

9. The method of claim 6, wherein the fluid stream is air and further comprising producing an oxygen-enriched stream.

10. The method of claim 7, wherein the fluid stream contains greater than about 90 vol. % argon and the oxygen-reduced fluid stream is a purified argon stream.

11. The method of claim 1, wherein the ZnMOF comprises one or more optionally substituted azole ligands.

12. The method of claim 11, wherein the ZnMOF is of the formula,
ZnₙXₚY_{q}Zₐ
or a solvate or hydrate thereof, wherein
a is 0 or an integer greater than 0;
n, p, and q are each integers greater than 0, where a, n, p, and q are selected such that the formula is a neutral compound;
X is one or more optionally substituted azole ligands;
Y is one or more multidentate ligands; and
Z is H₂O.

13. The method of claim 12, wherein a is 1.

14. The method of claim 12, wherein each X is independently of the formula, 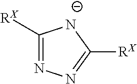
wherein
each R^{X} is independently hydrogen, halogen, —R^{X1}, C₁₋₄alkyl, C₁₋₄haloalkyl, C₂₋₄alkenyl, C₂₋₄alkynyl, —C₁₋₄alkyl-R^{X1}, —C₁₋₄alkyl-R^{X3}, wherein
each R^{X1} is independently —N(R^{X2})₂, —OR^{X2}, —C(O)R^{X2}, —C(O)OR^{X2}, —C(O)N(R^{X2})₂, —N(R^{X2})C(O)R^{X2}, —N(R^{X2})C(O)OR^{X2}, —N(R^{X2})C(O)N(R^{X2})₂, —N(R^{X2})S(O)₂R^{X2}, —N(R^{X2})S(O)₂OR^{X2}, —N(R^{X2})S(O)₂N(R^{X2})₂, —OC(O)R^{X2}, —OC(O)OR^{X2}, —OC(O)N(R^{X2})₂, aryl, heteroaryl, C₃₋₈cycloalkyl, or 3-8 membered heterocyclyl; and
each R^{X3} is independently nitro, cyano, —SR^{X2}, —SO₂R^{X2}, —SO₂OR^{X2}, —SO₂N(R^{X2})₂, —OS(O)₂R^{X2}, or —OS(O)₂OR^{X2}; wherein each R^{X2} is independently hydrogen or C₁₋₄alkyl.

15. The method of claim 12, wherein each Y is independently of the formula, 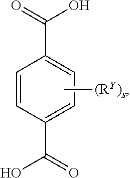
or a mono- or di-deprotonated form thereof,
wherein s is 0, 1, 2, 3, or 4; and
each R^{Y} is independently halogen, —R^{Y1}, C₁₋₄alkyl, C₁₋₄haloalkyl, C₂₋₄alkenyl, C₂₋₄alkynyl, —C₁₋₄alkyl-R^{Y1}, wherein
each R^{Y1} is independently nitro, cyano, —OR^{Y2}, —N(R^{Y2})₂, —SR^{Y2}, —C(O)R^{Y2}, —C(O)OR^{Y2}, —C(O)N(R^{Y2})₂, —SO₂R^{Y2}, —SO₂OR^{Y2}, —SO₂N(R^{Y2})₂, —OC(O)R^{Y2}, —N(R^{Y2})C(O)R^{Y2}, —OC(O)OR^{Y2}, —OC(O)N(R^{Y2})₂, —N(R^{Y2})C(O)OR^{Y2}, —N(R^{Y2})C(O)N(R^{Y2})₂, —OS(O)₂R^{Y2}, —N(R^{Y2})S(O)₂R^{Y2}, —OS(O)₂OR^{Y2}, —N(R^{Y2})S(O)₂OR^{Y2}, —N(R^{Y2})S(O)₂N(R^{Y2})₂, aryl, heteroaryl, C₃₋₈cycloalkyl, or 3-8 membered heterocyclyl, wherein each R^{Y2} is independently hydrogen or C₁₋₄alkyl.

16. The method of claim 12, wherein the ZnMOF is of the formula,
ZnₙXₚY¹_{q1}Y²_{q2}Zₐ (IIIa)
or a solvate or hydrate thereof, wherein
q1 and q2 are each integers greater than 0, and a, n, p, q1, and q2 are selected such that formula (IIIa) is a neutral compound;
Y¹ is of the formula, 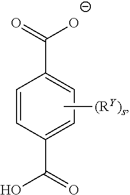
wherein s is 0, 1, 2, 3, or 4; and
each R^{Y} is independently halogen, —R^{Y1}, C₁₋₄alkyl, C₁₋₄haloalkyl, C₂₋₄alkenyl, C₂₋₄alkynyl, —C₁₋₄alkyl-R^{Y1}, wherein
each R^{Y1} is independently nitro, cyano, —OR^{Y2}, —N(R^{Y2})₂, —SR^{Y2}, —C(O)R^{Y2}, —C(O)OR^{Y2}, —C(O)N(R^{Y2})₂, —SO₂R^{Y2}, —SO₂OR^{Y2}, —SO₂N(R^{Y2})₂, —OC(O)R^{Y2}, —N(R^{Y2})C(O)R^{Y2}, —OC(O)OR^{Y2}, —OC(O)N(R^{Y2})₂, —N(R^{Y2})C(O)OR^{Y2}, —N(R^{Y2})C(O)N(R^{Y2})₂, —OS(O)₂R^{Y2}, —N(R^{Y2})S(O)₂R^{Y2}, —OS(O)₂OR^{Y2}, —N(R^{Y2})S(O)₂OR^{Y2}, —N(R^{Y2})S(O)₂N(R^{Y2})₂, aryl, heteroaryl, C₃₋₈cycloalkyl, or 3-8 membered heterocyclyl, wherein each R^{Y2} is independently hydrogen or C₁₋₄alkyl;
and
Y² is of the formula

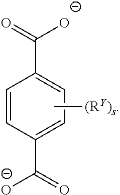

17. The method of claim 16, wherein the ZnMOF is of the formula, Zn₂XY¹Y²Z.

18. The method of claim 12, wherein the one or more optionally substituted azole ligands is 3-amino-[1,2,4]-triazolate, 2,5-diamino-[1,2,4]-triazolate, or a mixture thereof.

19. A Zn metal-organic framework (ZnMOF) of formula (IV),
ZnₙXₚY_{q}Zₐ (IV)
or a solvate or hydrate thereof, wherein
a is 0 or an integer greater than 0;
n, p, and q are each integers greater than 0, where a, n, p, and q are selected such that formula (IV) is a neutral compound;
each X is independently of the formula, 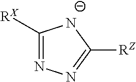
wherein
R^{X} is hydrogen or —R^{Z}; and
each R^{Z} is independently halogen, —R^{X1}, C₁₋₄alkyl, C₁₋₄haloalkyl, C₂₋₄alkenyl, C₂₋₄alkynyl, —C₁₋₄alkyl-R^{X1}, or —C₁₋₄alkyl-R^{X3}, wherein
each R^{X1} is independently —N(R^{X2})₂, —OR^{X2}, —C(O)R^{X2}, —C(O)OR^{X2}, —C(O)N(R^{X2})₂, —N(R^{X2})C(O)R^{X2}, —N(R^{X2})C(O)OR^{X2}, —N(R^{X2})C(O)N(R^{X2})₂, —N(R^{X2})S(O)₂R^{X2}, —N(R^{X2})S(O)₂OR^{X2}, or —N(R^{X2})S(O)₂N(R^{X2})₂, —OC(O)R^{X2}, —OC(O)OR^{X2}, —OC(O)N(R^{X2})₂, aryl, heteroaryl, C₃₋₈cycloalkyl, or 3-8 membered heterocyclyl; and
each R^{X3} is independently nitro, cyano, —SR^{X2}, —SO₂R^{X2}, —SO₂OR^{X2}, —SO₂N(R^{X2})₂, —OS(O)₂R^{X2}, or —OS(O)₂OR^{X2};
wherein each R^{X2} is independently hydrogen or C₁₋₄alkyl; and
each Y is independently of the formula, 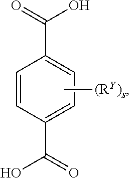
or a mono- or di-deprotonated form thereof,
wherein s is 0, 1, 2, 3, or 4; and
each R^{Y} is independently halogen, —R^{Y1}, C₁₋₄alkyl, C₁₋₄haloalkyl, C₂₋₄alkenyl, C₂₋₄alkynyl, or —C₁₋₄alkyl-R^{Y1}, wherein
each R^{Y1} is independently nitro, cyano, —OR^{Y2}, —N(R^{Y2})₂, —SR^{Y2}, —C(O)R^{Y2}, —C(O)OR^{Y2}, —C(O)N(R^{Y2})₂, —SO₂R^{Y2}, —SO₂OR^{Y2}, —SO₂N(R^{Y2})₂, —OC(O)R^{Y2}, —N(R^{Y2})C(O)R^{Y2}, —OC(O)OR^{Y2}, —OC(O)N(R^{Y2})₂, —N(R^{Y2})C(O)OR^{Y2}, —N(R^{Y2})C(O)N(R^{Y2})₂, —OS(O)₂R², —N(R^{Y2})S(O)₂R^{Y2}, —OS(O)₂OR^{Y2}, —N(R^{Y2})S(O)₂OR^{Y2}, or —N(R^{Y2})S(O)₂N(R^{Y2})₂, aryl, heteroaryl, C₃₋₈cycloalkyl, or 3-8 membered heterocyclyl, wherein each R^{Y2} is independently hydrogen or C₁₋₄alkyl.

20. The ZnMOF of claim 19, wherein, wherein the ZnMOF is of the formula,
ZnₙXₚY¹_{q1}Y²_{q2}Zₐ (IVa)
or a solvate or hydrate thereof, wherein
q1 and q2 are each integers greater than 0, and a, n, p, q1 and q2 are selected such that formula (IVa) is a neutral compound;
Y¹ is of the formula, 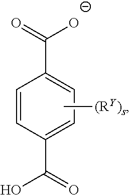
wherein s is 0, 1, 2, 3, or 4; and
each R^{Y} is independently halogen, —R^{Y1}, C₁₋₄alkyl, C₁₋₄haloalkyl, C₂₋₄alkenyl, C₂₋₄alkynyl, —C₁₋₄alkyl-R^{Y1}, wherein
each R^{Y1} is independently nitro, cyano, —OR^{Y2}, —N(R^{Y2})₂, —SR^{Y2}, —C(O)R^{Y2}, —C(O)OR^{Y2}, —C(O)N(R^{Y2})₂, —SO₂R^{Y2}, —SO₂OR^{Y2}, —SO₂N(R^{Y2})₂, —OC(O)R^{Y2}, —N(R^{Y2})C(O)R^{Y2}, —OC(O)OR^{Y2}, —OC(O)N(R^{Y2})₂, —N(R^{Y2})C(O)OR^{Y2}, —N(R^{Y2})C(O)N(R^{Y2})₂, —OS(O)₂R^{Y2}, —N(R^{Y2})S(O)₂R^{Y2}, —OS(O)₂OR^{Y2}, —N(R^{Y2})S(O)₂OR^{Y2}, —N(R^{Y2})S(O)₂N(R^{Y2})₂, aryl, heteroaryl, C₃₋₈cycloalkyl, or 3-8 membered heterocyclyl, wherein each R^{Y2} is independently hydrogen or C₁₋₄alkyl;
and
Y² is of the formula

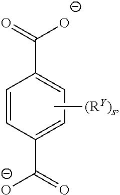

21. The ZnMOF of claim 20, wherein the ZnMOF is of the formula, Zn₂XY¹Y²Z.

22. The ZnMOF of claim 19, wherein X is 3-amino-[1,2,4]-triazolate, 2,5-diamino-[1,2,4]-triazolate, or a mixture thereof.

23. A method for preparing a ZnMOF, comprising heating a reaction mixture comprising H₂Y, HX, a zinc salt, a base, and a solvent under conditions suitable for formation of a MOF, wherein Y and X are defined as in claim 19.
